(19) United States
(12) Patent Application Publication
(10) Pub. No.: US 2026/0005788 A1
(43) Pub. Date: Jan. 1, 2026

(54) WIRELESS COMMUNICATION METHOD AND DEVICE

(71) Applicant: GUANGDONG OPPO MOBILE TELECOMMUNICATIONS CORP., LTD., Dongguan (CN)

(72) Inventors: Shengjiang CUI, Dongguan (CN); Weijie XU, Dongguan (CN)

(21) Appl. No.: 19/318,655

(22) Filed: Sep. 4, 2025

Related U.S. Application Data
(63) Continuation of application No. PCT/CN2023/092339, filed on May 5, 2023.

(51) Int. Cl. H04L 1/00; H04B 1/04; H04B 1/16; H04W 72/0453

(52) U.S. Cl. CPC H04L 1/0003; H04B 1/0475; H04B 1/1638; H04W 72/0453

(57) ABSTRACT

A wireless communication method includes: receiving, by an AMP device, a first signal and a second signal; performing, by the AMP device, a cross-modulation or inter-modulation processing on the first signal and the second signal to obtain a third signal; and decoding, by the AMP device, the first signal according to the third signal.

### CROSS-REFERENCE TO RELATED APPLICATION

This application is a Continuation Application of International Application No. PCT/CN2023/092339 filed on May 5, 2023, which is incorporated herein by reference in its entirety.

### TECHNICAL FIELD

Embodiments of the present disclosure relate to the field of communications, and in particular, to a wireless communication method and device.

### BACKGROUND

An ambient power (AMP) device has a low complexity and a low cost, which enables to be maintenance-free and battery-free, may support power harvesting and/or a backscatter communication, and may realize a high-density and large-scale deployment at a lower cost. Considering service features of the AMP device, limitations of the AMP device's capability, and a limitation of the AMP device's operating power consumption, how to obtain an intermediate frequency signal of a received signal and decode the received signal by the AMP device is a problem that needs to be solved.

### SUMMARY

Embodiments of the present disclosure provide a wireless communication method and device.

In a first aspect, a wireless communication method is provided, and the method includes:
receiving, by an AMP device, a first signal and a second signal;
performing, by the AMP device, a cross-modulation or inter-modulation processing on the first signal and the second signal to obtain a third signal; and
decoding, by the AMP device, the first signal according to the third signal.

In a second aspect, a wireless communication method is provided, and the method includes:
transmitting, by a first communication device, a first signal and/or a second signal to an AMP device;
where a third signal obtained from a cross-modulation or inter-modulation processing of the first signal and the second signal is used to decode the first signal;
where in a case where the first communication device only transmits the first signal, the second signal is transmitted to the AMP device by a second communication device triggered by the first communication device; or, in a case where the first communication device only transmits the second signal, the second signal is transmitted to the AMP device after a trigger of a second communication device.

In a third aspect, an AMP device is provided, and configured to perform the method in the first aspect described above.

For example, the AMP device includes a functional module that is configured to perform the method in the first aspect described above.

In a fourth aspect, a communication device is provided, the communication device is a first communication device, and the communication device is configured to perform the method in the second aspect described above. For example, the communication device includes a functional module that is configured to perform the method in the second aspect described above.

In a fifth aspect, an AMP device is provided, and includes a processor and a memory; the memory is configured to store a computer program, and the processor is configured to call and execute the computer program stored in the memory, to cause the AMP device to perform the method in the first aspect described above.

In a sixth aspect, a communication device is provided; the communication device is a first communication device, and the communication device includes a processor and a memory; the memory is configured to store a computer program, and the processor is configured to call and execute the computer program stored in the memory, to cause the communication device to perform the method in the second aspect described above.

In a seventh aspect, there is provided an apparatus. The apparatus is configured to implement the method in any one of the first aspect to the second aspect described above.

For example, the apparatus includes a processor, configured to call and execute a computer program from a memory, to cause a device equipped with the apparatus to perform the method in any one of the first aspect to the second aspect described above.

In an eighth aspect, there is provided a non-transitory computer-readable storage medium, configured to store a computer program, and the computer program causes a computer to perform the method in any one of the first aspect to the second aspect described above.

In a ninth aspect, there is provided a computer program product, including computer program instructions, and the computer program instructions cause a computer to perform the method in any one of the first aspect to the second aspect described above.

In a tenth aspect, there is provided a computer program. The computer program, when executed on a computer, causes a computer to perform the method in any one of the first aspect to the second aspect described above.

### BRIEF DESCRIPTION OF THE DRAWINGS

FIG. 1 is a schematic diagram of a communication system architecture applied in the embodiments of the present disclosure.

FIG. 2 is a schematic diagram of a zero-power consumption communication provided in the present disclosure.

FIG. 3 is a schematic diagram of a backscatter communication provided in the present disclosure.

FIG. 4 is a schematic diagram of power harvesting provided in the present disclosure.

FIG. 5 is a circuit schematic diagram of a resistive load modulation provided in the present disclosure.

FIG. 6 is a schematic diagram of a second-order cross-modulation or inter-modulation component provided in the present disclosure.

FIG. 7 is a schematic diagram of a third-order cross-modulation or inter-modulation component provided in the present disclosure.

FIG. 8 is a schematic diagram of a channel bandwidth provided in the present disclosure.

FIG. 9 is a schematic diagram of an IF signal obtained from cross-modulation or inter-modulation of signals with two frequencies provided in the present disclosure.

FIG. 10 is a schematic flowchart of a wireless communication method provided according to the embodiments of the present disclosure.

FIG. 11A to FIG. 14 are schematic diagrams for transmitting a first signal and a second signal, respectively, according to the embodiments of the present disclosure.

FIG. 15 is a schematic block diagram of an AMP device provided according to the embodiments of the present disclosure.

FIG. 16 is a schematic block diagram of a communication device provided according to the embodiments of the present disclosure.

FIG. 17 is a schematic block diagram of another communication device provided according to the embodiments of the present disclosure.

FIG. 18 is a schematic block diagram of an apparatus provided according to the embodiments of the present disclosure.

FIG. 19 is a schematic block diagram of a communication system provided according to the embodiments of the present disclosure.

### DETAILED DESCRIPTION

Technical solutions in the embodiments of the present disclosure will be described below in conjunction with drawings of the embodiments of the present disclosure. Obviously, the described embodiments are some but not all of the embodiments of the present disclosure. All other embodiments obtained by those ordinary skilled in the art based on the embodiments of the present disclosure shall fall within the protection scope of the present disclosure.

The technical solutions in the embodiments of the present disclosure may be applied to various communication systems, such as: a global system of mobile communication (GSM) system, a code division multiple access (CDMA) system, a wideband code division multiple access (WCDMA) system, a general packet radio service (GPRS), a long term evolution (LTE) system, an advanced long term evolution (LTE-A) system, a new radio (NR) system, an evolution system of the NR system, an LTE-based access to unlicensed spectrum (LTE-U) system, an NR-based access to unlicensed spectrum (NR-U) system, a non-terrestrial communication networks (Non-Terrestrial Networks, NTN) system, a universal mobile telecommunications system (UMTS), wireless local area networks (WLAN), Internet of Things (IoT), wireless fidelity (WiFi), a 5th-generation (5G) communication system, a 6th-generation (6G) communication system, or other communication systems, etc.

Generally speaking, traditional communication systems support a limited number of connections, which is also easy to be implemented. However, with the development of the communication technology, mobile communication systems will not only support traditional communications, but also support, for example, device to device (D2D) communication, machine to machine (M2M) communication, machine type communication (MTC), vehicle to vehicle (V2V) communication, a sidelink (SL) communication, or vehicle to everything (V2X) communication, etc. The embodiments of the present disclosure may be applied to these communication systems as well.

In some embodiments, the communication system in the embodiments of the present disclosure may be applied to a carrier aggregation (CA) scenario, a dual connectivity (DC) scenario, and may also be applied to a standalone (SA) network deployment scenario, or applied to a non-standalone (NSA) network deployment scenario.

In some embodiments, the communication system in the embodiments of the present disclosure may be applied to an unlicensed spectrum, where the unlicensed spectrum may also be considered as a shared spectrum. Alternatively, the communication system in the embodiments of the present disclosure may be applied to a licensed spectrum, where the licensed spectrum may be considered as an unshared spectrum.

In some embodiments, the communication system in the embodiments of the present disclosure may be applied to a FR1 band (corresponding to a frequency band range of 410 MHz to 7.125 GHz), and may also be applied to an FR2 frequency band (corresponding to a frequency band range of 24.25 GHz to 52.6 GHz), and may also be applied to a new frequency band, such as a high-frequency band corresponding to a frequency band range of 52.6 GHz to 71 GHz or corresponding to a frequency band range of 71 GHz to 114.25 GHz.

The embodiments of the present disclosure describe various embodiments in conjunction with an AMP device and a communication device. The AMP device may also be referred to as a zero-power consumption device or an ambient power Internet of Things device. The communication device may be a network device (e.g., a base station), or an access point (AP), or a terminal device, or a station (STA), or a transmission reception point (TRP), or a relay device. Of course, the communication device may also be another device, which is not limited in the embodiments of the present disclosure.

The terminal device may be a cellular phone, a cordless phone, a session initiation protocol (SIP) phone, a wireless local loop (WLL) station, a personal digital assistant (PDA) device, a handheld device with a wireless communication function, a computing device or another processing device connected to a wireless modem, a vehicle-mounted device, a wearable device, a terminal device in a next-generation communication system such as an NR network, a terminal device in a future evolved public land mobile network (PLMN) network, or the like.

In the embodiments of the present disclosure, the terminal device may be deployed on land, including indoor or outdoor, handheld, wearable, or in-vehicle; the terminal device may also be deployed on water (e.g., on a steamship, etc.); the terminal device may also be deployed in air (e.g., on an airplane, on a balloon, or on a satellite, etc.).

In the embodiments of the present disclosure, the terminal device may be a mobile phone, a pad, a computer with a wireless transceiver function, a virtual reality (VR) terminal device, an augmented reality (AR) terminal device, a wireless terminal device in industrial control, a wireless terminal device in self-driving, a wireless terminal device in remote medical, a wireless terminal device in smart grid, a wireless terminal device in transportation safety, a wireless terminal device in smart city, or a wireless terminal device in smart home, an in-vehicle communication device, a wireless communication chip/application specific integrated circuit (ASIC)/system on chip (SoC), or the like.

As an example but not a limitation, in the embodiments of the present disclosure, the terminal device may also be a wearable device. The wearable device may be referred to as a wearable smart device, which is a general term for wearable devices developed by performing the intellectualized design on daily wear by applying wearable technologies, such as glasses, gloves, watches, clothing and shoes, etc. The wearable device is a portable device that is worn directly on a body, or integrated into the clothes or accessories of users. The wearable device not only is a hardware device, but also implements powerful functions by software support as well as data interaction or cloud interaction. Generalized wearable smart devices include devices, that are fully functional, large in size and may implement full or partial functions without relying on smart phones, such as smart watches or smart glasses; as well as devices, that only focus on a certain type of application function and need to be used in conjunction with other devices (e.g., a smart phone), such as various smart bracelets and smart jewelry that monitor physical signs, or the like.

In the embodiments of the present disclosure, the network device may be a device for communicating with a mobile device, and the network device may be an access point (AP) in the WLAN, a base station (Base Transceiver Station, BTS) in the GSM or CDMA, or may also be a base station (NodeB, NB) in the WCDMA, or may also be an evolutional base station (Evolutional Node B, eNB or eNodeB) in the LTE, or a relay station or an access point, or an in-vehicle device, a wearable device, a network device or a base station (gNB) or a transmission reception point (TRP) in the NR network, a network device in the future evolved PLMN network, a network device in the NTN network, or the like.

As an example but not a limitation, in the embodiments of the present disclosure, the network device may have mobile characteristics. For example, the network device may be a mobile device. In some embodiments, the network device may be a satellite, or a balloon station. For example, the satellite may be a low earth orbit (LEO) satellite, a medium earth orbit (MEO) satellite, a geostationary earth orbit (GEO) satellite, or a high elliptical orbit (HEO) satellite, etc. In some embodiments, the network device may also be a base station disposed on land, water, or other places.

In the embodiments of the present disclosure, the network device may provide a service for a cell, and the terminal device communicates with the network device through a transmission resource (e.g., a frequency-domain resource, or in other words, a spectrum resource) used by the cell. The cell may be a cell corresponding to the network device (e.g., a base station), and the cell may belong to a macro base station, or may belong to a base station corresponding to a small cell. The small cell here may include: a metro cell, a micro cell, a pico cell, or a femto cell, or the like. These small cells have characteristics of small coverage ranges and low transmission power, which are applicable for providing a data transmission service with high speed.

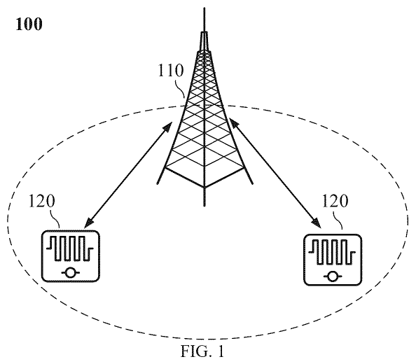

Exemplarily, a communication system 100 applied in the embodiments of the present disclosure is shown in FIG. 1. The communication system 100 may include a communication device 110, and the communication device 110 may be a device communicating with AMP devices 120 (or also referred to as zero-power consumption devices). The communication device 110 may provide a communication coverage for a specific geographic area and may communicate with the AMP devices located within the coverage area.

FIG. 1 exemplarily shows one communication device and two AMP devices. Optionally, the communication system 100 may include a plurality of communication devices, and another number of AMP devices may be included within a coverage area of each communication device, which is not limited in the embodiments of the present disclosure.

In some embodiments, the communication system 100 may further include other network entities such as a network controller, a mobility management entity, or the like, which are not limited in the embodiments of the present disclosure.

It should be understood that, in the embodiments of the present disclosure, a device with a communication function in the network/system may be referred to as a communication device. Taking the communication system 100 shown in FIG. 1 as an example, the communication device may include a communication device 110 with a communication function and an AMP device 120 with a communication function. The communication device 110 and the AMP device 120 may be the exemplary devices described above, which will not be repeated here. The communication device may further include other devices in the communication system 100, such as a network controller, a mobility management entity, and other network entities, which are not limited in the embodiments of the present disclosure.

It should be understood that the terms “system” and “network” are often used interchangeably herein. The term “and/or” herein is only an association relationship to describe associated objects, indicating that there may be three kinds of relationships, and for example, “A and/or B” may represent three cases where: A exists alone, both A and B exist, and B exists alone. In addition, a character “/” herein generally indicates that the associated objects before and after this character are in an “or” relationship.

Terms used in the implementations of the present disclosure are only used to explain the embodiments of the present disclosure, but are not intended to limit the present disclosure. The terms such as “first”, “second”, “third”, “fourth”, etc., in the specification, claims and drawings of the present disclosure are used to distinguish different objects, rather than to describe a specific order. In addition, the terms “include”, “comprise”, “have” and any variations thereof, are intended to cover non-exclusive inclusions.

It should be understood that “indicate” and variations thereof mentioned in the embodiments of the present disclosure may mean a direct indication, an indirect indication, or may mean that there is an association relationship. For example, A indicating B may mean that A directly indicates B, and for example, B may be acquired by A; alternatively, A indicating B may mean that A indirectly indicates B, and for example, A indicates C, and B may be acquired by C; alternatively, A indicating B may mean that there is an association relationship between A and B.

It should be understood that “at least one/a or at least one of” mentioned in the embodiments of the present disclosure may mean “one or more”, and the “positive integer” mentioned in the embodiments of the present disclosure may mean “1, 2, 3 . . . , or other values”, and the “non-negative integer” mentioned in the embodiments of the present disclosure may mean “0, 1, 2, 3 . . . , or other values”, and the “integer” mentioned in the embodiments of the present disclosure may mean “ . . . , −3, −2, −1, 0, 1, 2, 3, . . . or other values”, which may be replaced with any possible value based on requirements of the embodiments.

It should be understood that the figures and/or tables shown in the embodiments of the present disclosure are merely examples. For example, in some cases, some of the information contained in the figures and/or tables shown in the embodiments of the present disclosure may independently constitute an optional embodiment. For example, each row or each column in a table may independently constitute an optional embodiment, which is not limited in the present disclosure.

In the description of the embodiments of the present disclosure, the term “corresponding” and variations thereof may mean that there is a direct correspondence or an indirect correspondence between the two, or may mean that there is an association relationship between the two, or may mean a relationship of indicating and being indicated, or a relationship of configuring and being configured, or the like.

In the embodiments of the present disclosure, the “predefined” or “pre-configured” and variations thereof may be implemented by pre-saving corresponding codes, tables or other manners that may be used to indicate related information, in the device (for example, including the terminal device and the network device), and the present disclosure does not limit its specific implementation. For example, the predefined may refer to what is defined in a protocol.

In the embodiments of the present disclosure, the term “protocol” may refer to a standard protocol in the field of communications, for example, the “protocol” may be an evolution of the existing LTE protocol, NR protocol, Wi-Fi protocol, or a protocol related to other relevant communication systems, and the present disclosure does not limit the protocol type.

In order to better understand the embodiments of the present disclosure, the zero-power consumption communication technology related to the present disclosure will be described.

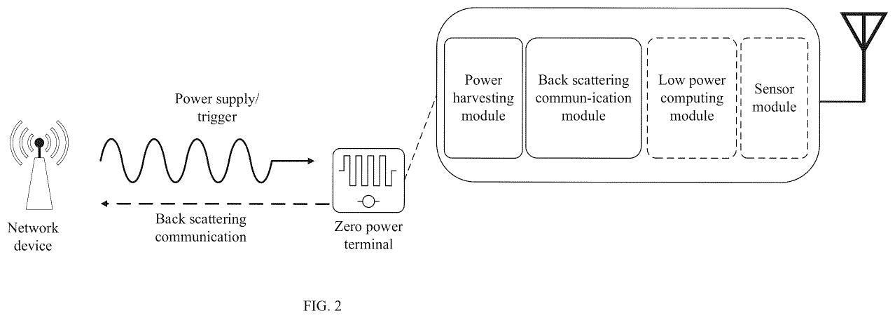

The zero-power consumption communication uses power harvesting and/or backscatter communication technologies. A zero-power consumption communication network consists of a network device and a zero-power consumption device (e.g., a zero-power terminal), as shown in FIG. 2. The network device is configured to transmit a wireless power supply signal and a downlink communication signal to the zero-power consumption device, and receive a backscattered signal from the zero-power consumption device. A basic zero-power consumption device includes a power harvesting module, a backscatter communication module and a low-power consumption computing module. In addition, the zero-power consumption device may also have a memory or sensor, for storing some basic information (e.g., an item identifier, etc.) or acquiring sensing data such as ambient temperature and ambient humidity, etc.

Key technologies of the zero-power consumption communication mainly include radio frequency (RF) power harvesting and backscatter communication (Back Scattering).

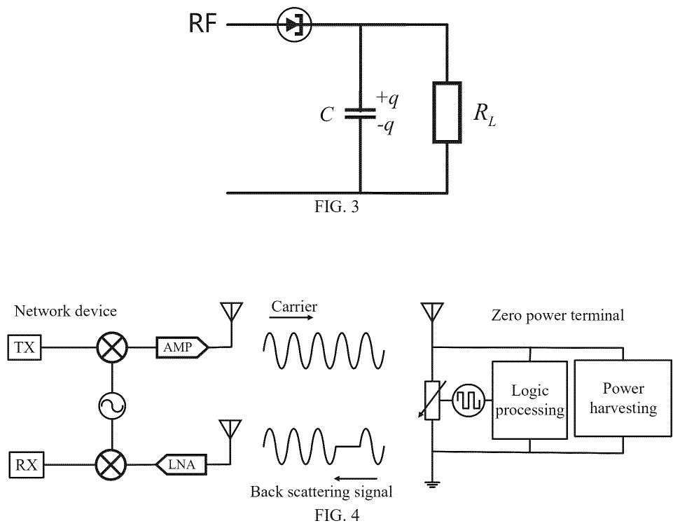

For example, the radio frequency power harvesting (RF Power Harvesting) may be shown in FIG. 3. The radio frequency power harvesting module implements to harvest spatial electromagnetic wave power based on the electromagnetic induction principle, and then obtains power required for driving an operation of the zero-power consumption device, to for example drive a low-power consumption demodulation and modulation module, a sensor, and memory reading, etc. Therefore, the zero-power consumption device does not need a traditional battery.

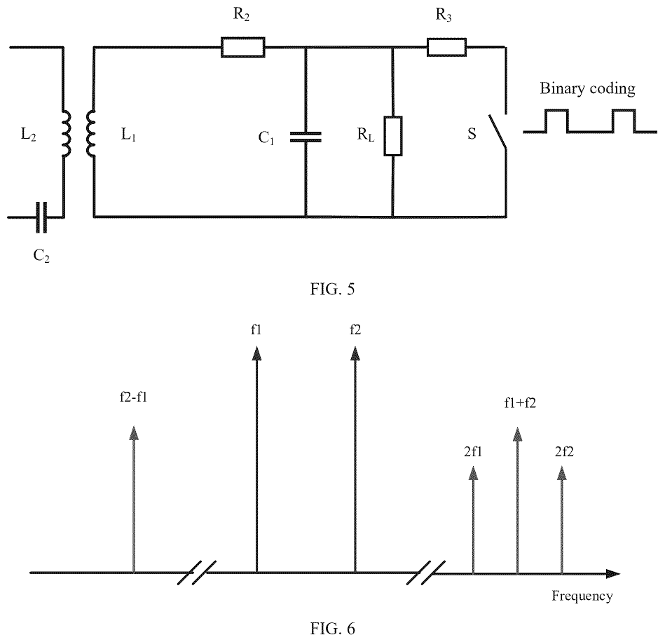

For example, the backscatter communication (Back Scattering) may be shown in FIG. 4. The zero-power consumption communication terminal receives a wireless signal transmitted from a network, and modulates the wireless signal, loads information to be transmitted, and radiates the modulated signal from an antenna. This information transmission process is referred to as a backscatter communication. The backscatter and load modulation functions are inseparable. The load modulation adjusts and controls circuit parameter(s) of an oscillation loop circuit of the zero-power consumption device according to a rhythm of a data stream, to enable that the magnitude and other parameters of the impedance of the electronic tag are changed accordingly, so as to complete a process of modulation. The load modulation technology mainly includes two modes: resistive load modulation and capacitive load modulation. In the resistive load modulation, a resistor is connected in parallel with the load, and the resistor is turned on or off based on the control of a binary data stream, as shown in FIG. 5. The on and off of the resistor will cause the change of the circuit voltage, thereby implementing amplitude keying (Amplitude Shift Keying, ASK) modulation. That is, the modulation and transmission of the signal are implemented by adjusting the magnitude of the amplitude of the backscatter signal of the zero-power consumption device. Similarly, in the capacitive load modulation, the change of the resonant frequency of the circuit may be implemented by the on and off of the capacitor, thereby implementing frequency keying (Frequency Shift Keying, FSK) modulation. That is, the modulation and transmission of the signal are implemented by adjusting the operating frequency of the backscatter signal of the zero-power consumption device.

It can be seen that the zero-power consumption device performs information modulation on an incoming wave signal by means of the load modulation mode, thereby implementing the backscatter communication process. Therefore, the zero-power consumption device has significant advantages that:
(1) the zero-power consumption device does not actively transmit a signal, so it does not need a complex radio frequency link, such as a PA, a radio frequency filter, etc.;
(2) the zero-power consumption device does not need to actively generate a high-frequency signal, so it does not need a high-frequency crystal oscillator; and
(3) by means of the backscatter communication, the zero-power consumption device's signal transmission does not need to consume the zero-power consumption device's own power.

The zero-power consumption communication may be widely used in various industries due to its significant advantages such as extremely low cost, zero-power consumption, and small size, such as logistics, smart warehousing, smart agriculture, power and electricity, industrial Internet, etc., oriented to vertical industries; it may also be applied to personal applications such as the smart wearable and smart home.

In order to better understand the embodiments of the present disclosure, a power supply signal and a trigger signal in the zero-power consumption communication system related to the present disclosure are described.

The power supply signal: in terms of a power supply signal carrier, it may be a base station, a smart phone, a smart gateway, a charging station, a micro base station, or the like; in terms of a frequency band, a radio wave used for power supply may be at a low frequency, an intermediate frequency, a high frequency, or the like; in terms of a waveform, the radio wave used for power supply may be a sine wave, a square wave, a triangular wave, a pulse, a rectangular wave, or the like; in addition, the radio wave may be a continuous wave or a discontinuous wave (i.e., a certain time interruption is allowed). The power supply signal may be a signal specified in the 3GPP standard, such as a sounding reference signal (SRS), a physical uplink shared channel (PUSCH), a physical random access channel (PRACH), a physical uplink control channel (PUCCH), a physical downlink control channel PDCCH), a physical downlink shared channel (PDSCH), or a physical broadcast channel (PBCH).

The trigger signal/control information: in terms of a trigger signal carrier, it may be a base station, a smart phone, a smart gateway, or the like; in terms of a frequency band, a radio wave used for power supply may be a low frequency, an intermediate frequency, a high frequency, or the like; in terms of a waveform, the radio wave used for power supply may be a sine wave, a square wave, a triangular wave, a pulse, a rectangular wave, or the like; in addition, the radio wave may be a continuous wave or a discontinuous wave (i.e., a certain time interruption is allowed). The trigger signal may be a signal specified in the 3GPP standard, such as an SRS, a PUSCH, a PRACH, a PUCCH, a PDCCH, a PDSCH, or a PBCH; it may also be a new signal.

In order to better understand the embodiments of the present disclosure, the classification of the zero-power consumption device related to the present disclosure is described.

Optionally, based on power sources and usage modes of the zero-power consumption device, the zero-power consumption device may be classified into a passive zero-power consumption device, a semi-passive zero-power consumption device and an active zero-power consumption device.

### 1) the Passive Zero-Power Consumption Device

The zero-power consumption device does not need an internal battery, and when the zero-power consumption device approaches the network device (such as the reader/writer in the radio frequency identification (RFID) system), the zero-power consumption device is located within a near field range formed by antenna radiation of the network device. Therefore, the antenna of the zero-power consumption device generates an induced current through electromagnetic induction, and the induced current drives a low-power consumption chip circuit of the zero-power consumption device. Demodulation of a forward link signal (downlink, a link from the network device to the zero-power consumption device), and modulation of a backward link (uplink, a link from the zero-power consumption device to the network device) signal and other operations are implemented. For the backscatter link, the zero-power consumption device transmits a signal by the backscatter implementation.

It may be seen that the passive zero-power consumption device does not need an internal battery to drive both the forward link and the backward link, and is a true zero-power consumption device.

The passive zero-power consumption device does not need the battery, the radio frequency circuit and the baseband circuit are very simple, and they do not need, for example, a low-noise amplifier (LNA), a power amplifier (PA), a crystal oscillator, analog-to-digital converters (Analog-to-digital conversion, ADC) and other devices. Therefore, the passive zero-power consumption device has many advantages such as small size, light weight, very cheap price, and long service life, etc.

The passive zero-power consumption terminal may also support other power harvesting modes, in which it performs power harvesting on power (e.g., light power, thermal power, kinetic power, or mechanical power, etc.) in the environment, to obtain power for driving a circuit to support the terminal device for communications.

### 2) the Semi-Passive Zero-Power Consumption Device

The semi-passive zero-power consumption device is also not equipped with a conventional battery itself, but may use an radio frequency (RF) power harvesting module to harvest radio wave power, or use the power harvesting module to harvest power (e.g., solar power, thermal power, mechanical vibration power, etc.) in the environment, and meanwhile, store the harvested power into a power storage unit (such as a capacitor). After obtaining the power, the power storage unit may drive a low-power consumption chip circuit of the zero-power consumption device. Demodulation of the forward link signal, modulation of the backward link signal and other operations are implemented. For the backscatter link, the zero-power consumption device transmits a signal by the backscatter implementation.

It can be seen that the semi-passive zero-power consumption device does not need an internal battery to drive both the forward link and the backward link. Although the power stored in the capacitor is used in the operation, the power comes from the radio power harvested by the power harvesting module. Therefore, it is also a true zero-power consumption device.

The semi-passive zero-power consumption device inherits many advantages of the passive zero-power consumption device, so it has many advantages such as small size, light weight, very cheap price and long service life.

### 3) the Active Zero-Power Consumption Device

The zero-power consumption device used in some scenarios may also be an active zero-power consumption device, and this type of terminal may have an internal battery (a conventional battery, such as a dry battery, or a rechargeable lithium battery, etc.). The battery is used to drive a low-power consumption chip circuit of the zero-power consumption device. Demodulation of the forward link signal, and modulation of the backward link signal and other operations are implemented. However, for the backscatter link, the zero-power consumption device transmits a signal by the backscatter implementation. Therefore, the zero-power consumption of this type of terminal is mainly reflected in the fact that the signal transmission of the backward link does not need the terminal's own power, but uses the backscatter mode. Although the active zero-power consumption device uses the battery, the power consumption is very low due to the use of the ultra-low power consumption communication technology, and thus an operating life of the battery may be greatly improved compared to the prior art.

The active zero-power consumption device is equipped with an internal battery to supply power for an RFID chip, to increase a reading-writing distance of the tag and improve the reliability of communications. Therefore, it may be applied in some scenarios with relatively high requirements on aspects such as the communication distance, reading latency, or the like.

Some zero-power consumption terminals, such as a semi-passive zero-power consumption terminal or an active zero-power consumption terminal, may have a capability of active transmission, that is, the backward link may communicate by using an active transmission mode in addition to communicating in the backscatter mode.

As is well known, the service type of the zero-power consumption Internet of Things and service types of other Internet of Things will mainly focus on uplink services. Therefore, based on the transmitter type, the zero-power consumption device may be classified into a zero-power consumption device based on backscatter, a zero-power consumption device based on an active transmitter, and a zero-power consumption device with both backscatter and active transmitters.

### 1) the Zero-Power Consumption Device Based on Backscatter

This type of zero-power consumption device transmits uplink data by using the aforementioned backscatter mode. This type of device does not have an active transmitter for the active transmission, but only has a transmitter for the backscatter. Therefore, when this type of zero-power consumption device transmits data, the network device needs to provide a carrier, and this type of terminal device performs backscatter based on the carrier, to implement the data transmission.

### 2) the Zero-Power Consumption Device Based on an Active Transmitter

This type of zero-power consumption device uses an active transmitter with an active transmission capability for an uplink data transmission, therefore, when transmitting data, this type of zero-power consumption device may transmit the data by using its own active transmitter, without the need for the network device to provide a carrier. The active transmitter applicable for the zero-power consumption device may be, for example, an ultra-low power consumption ASK, an ultra-low power consumption FSK transmitter, etc., and based on the current implementation, in a case where this type of transmitter transmits a 100 w signal, its overall power consumption may be reduced to 400 to 600 w.

3) the Zero-Power Consumption Device with Both Backscatter and Active Transmitters

This type of terminal may support both backscatter and active transmitters. According to different situations (such as an electric quantity condition, available ambient power), or based on scheduling of the network device, the terminal may determine to use which transmission mode for an uplink signal: whether to use the backscatter mode or use the active transmitter for the active transmission.

In order to better understand the embodiments of the present disclosure, a cellular passive Internet of Things related to the present disclosure is described.

The cellular Internet of Things is booming. For example, 3GPP has standardized Internet of Things technologies such as narrow band Internet of Things (NB-IoT), machine type communication (MTC), or reduced capability (RedCap), etc. However, there are Internet of Things communication requirements in many scenarios that still cannot be met by using the prior art.

A harsh communication environment is taken as an example. Some Internet of Things scenarios may face extreme environments with high temperature, extremely low temperature, high humidity, high voltage, high radiation or high-speed movement, etc., such as an ultra-high voltage substation, high-speed train track monitoring, environment monitoring in a high-cold area, industrial production lines, etc. In these scenarios, existing IoT terminals will be unable to operate due to the limitations of the operating environment of traditional power supplies. In addition, the extreme operating environments are not conducive to the maintenance for the Internet of Things, such as the replacement of the battery.

A demand for an extremely small size of the terminal form is taken as another example. Some Internet of Things communication scenarios, such as the food traceability, commodity circulation, and smart wearables, require terminals to have an extremely small size to facilitate the use in these scenarios. For example, Internet of Things terminals used for commodity management in the circulation process usually use the form of electronic tags, which are embedded in the commodity packaging in a very small form. For another example, lightweight wearable devices may meet user needs while improving user experiences.

Extremely low-cost Internet of Things communication requirements are taken as yet another example. Numerous Internet of Things communication scenarios require the cost of Internet of Things terminals to be low enough, to improve their competitiveness with respect to other alternative technologies. For example, in logistics or warehousing scenarios, to facilitate the management of a large number of circulating goods, the Internet of Things terminal may be attached onto each goods, so that the accurate management of the entire process and entire cycle of the logistics may be completed through the communication between the terminal and the logistics network. These scenarios require the prices of Internet of Things terminals to be sufficiently competitive.

Therefore, in order to cover these unmet Internet of Things communication needs, in the cellular network, the Internet of Things with the ultra low cost, extremely small size, and free battery/free maintenance also needs to be developed, and the zero-power consumption Internet of Things may just meet these needs.

It should be additionally pointed out that the zero-power consumption Internet of Things may also be referred to as ambient power enabled Internet of Things (Ambient power enabled IoT), or ambient power Internet of Things (Ambient IoT) for short. For example, an ambient power Internet of Things device (Ambient IoT device) refers to an Internet of Things device (IoT device) that uses various ambient power, such as wireless radio frequency power, light power, solar power, thermal power, or mechanical power, etc. The Ambient IoT device may have no power storage capability, or may have very limited power storage capability (e.g., using a capacitor with a capacity of several tens of microfarads (uF).

In some embodiments, the Ambient IoT device may be used in at least the following four scenarios:
object recognition, such as logistics, production line product management, and supply chain management;
environmental monitoring, such as monitoring of temperature, humidity and harmful gases of the working environment and natural environment;
positioning, such as indoor positioning, intelligent object finding, production line goods positioning, etc.; and
intelligent controlling, such as intelligent control of various electrical appliances in smart home (turning on and off air conditioners, adjusting temperature), and intelligent control of various facilities in agricultural greenhouses (automatic irrigation and fertilization).

In order to better understand the embodiments of the present disclosure, inter-modulation (Inter Modulation) and cross-modulation (Cross Modulation) related to the present disclosure are described.

The cross-modulation (Cross Modulation) refers to a modulation of a wanted signal, by an unwanted signal generated by an interaction of signals in a nonlinear device, a network or a communication medium. New components are generated by an interaction of spectral components of one or more input signals, and their frequencies are equal to a linear combination of integer multiples of frequencies of components of the input signals.

The inter-modulation (Inter Modulation) occurs in a process in a nonlinear device or a propagation medium. New components are generated by an interaction of spectral components of one or more input signals, and their frequencies are equal to a linear combination of integer multiples of frequencies of components of the input signals.

For example, in many cases, the input signal will generate harmonic components when passing through a nonlinear transmission network (a nonlinear characteristic of a radio frequency device), and these harmonic components are integer multiples of a fundamental frequency f, such as 2f, 3f, or 4f, etc. Generally speaking, at a higher frequency, amplitudes of these harmonics will gradually decrease.

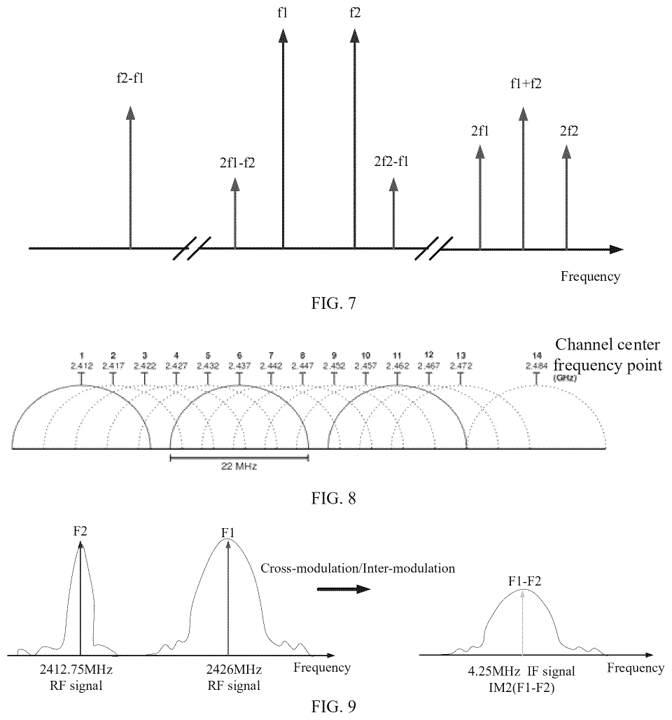

For example, when two radio frequency signals f1 and f2 pass through a passive device, inter-modulation signals with orders 2/3/4/5/6/7 or the like will be generated, and frequencies 2f1, 2f2, (f1+f2) and (f2−f1) are products of a second-order cross-modulation or inter-modulation. As shown in FIG. 6, f1+f2 and f2−f1 are second-order inter-modulation components, which may be represented by IM2(f2−f1) and IM2(f1+f2). If the second-order signal components 2f1 and 2f2 are mixed with the first-order signal components f1 and f2, new frequencies may be obtained. As shown in FIG. 7, two third-order cross-modulation or inter-modulation products are: (2f1−f2), (2f2−f1).

In order to better understand the embodiments of the present disclosure, a channel in WiFi related to the present disclosure is described.

Wi-Fi is a WLAN based on the IEEE 802.11 standard. There are many standard protocols for a wireless local area network (WLAN), such as an IEEE 802.11 protocol family or a HiperLAN protocol family, etc.

A WLAN channel list is wireless channels that an IEEE 802.11 (or referred to as WiFi) wireless network should use.

Two independent frequency bands, 2.4 GHz and 4.9/5.8 GHz, are divided by the 802.11 working group. Each frequency band is further divided into several channels, and each country formulates its own policies on how to use these frequency bands, as shown in Table 1.

TABLE 1

| Country | 2.4 GHz | 5 GHz (4.9/5.8) |
|---|---|---|
| China | 2.412-2.472 GHz: | 5.725-5.825 GHz: |
| | 13 channels | 4 channels |
| America | 2.412-2.462 GHz: | 5.15-5.35 GHz, |
| (FCC) | 11 channels | 5.725-5.825 GHz; |
| | | 12 channels |
| North | 2.412-2.462 GHz: | 5.15-5.35 GHz, |
| America | 11 channels | 5.725-5.825 GHz: |
| (except | | 12 channels |
| FCC) | | |
| Europe | 2.412-2.472 GHz: | 5.15-5.35 GHz: |
| (ETSI) | 13 channels | 8 channels |
| | | 5470-5725 MHz: |
| | | 11 channels |
| Israel | 2.432-2.472 GHz: | 5.15-5.35 GHz: |
| | 9 channels | 8 channels |
| Japan | 2.412-2.472 GHz: | 2.412-2.484 GHz: |
| | 13 channels (OFDM) | 14 channels (CCK) |
| | | 5.15-5.25 GHz: |
| | | 4 channels |
| Japan 2 | 2.412-2.472 GHz: | CCK5.15-5.35 GHz: |
| | 13 channels OFDM | 8 channels |
| | 2.412-2.484 GHz: | |
| | 14 channels | |
| South | 2.412-2.472 GHz: | 5.15-5.35 GHz, |
| Korea | | 5.46-5.72 GHz, |
| | 13 channels | 5.725-5.825 GHz: |
| | | 19 channels |
| Singapore | 2.412-2.472 GHz: | 5.15-5.35 GHz, |
| | 13 channels | 5.725-5.825 GHz: |
| | | 12 channels |
| Taiwan, | 2.412-2.462 GHz: | 5.25-5.35 GHz, |
| China | 11 channels | 5.725-5.825 GHz: |
| | | 7 channels |

An effective bandwidth of the channel is 20 MHz, and an actual bandwidth is 22 MHz, of which 2 MHz is an isolation band, as shown in FIG. 8.

Center frequency points of adjacent channels are spaced 5 MHz apart, there is a frequency overlap between a pluralities of adjacent channels, and there are three sets of channels that do not interfere with each other (1, 6, 11, or 2, 7, 12, or 3, 8, 13), as shown in Table 2.

TABLE 2

| | Bandwidth | Center |
|---|---|---|
| Channel | (MHz) | frequency (MHz) |
| 1 | 20 | 2412 (2401-2423) |
| 2 | 20 | 2417 |
| 3 | 20 | 2422 |
| 4 | 20 | 2427 |
| 5 | 20 | 2432 |
| 6 | 20 | 2437 |
| 7 | 20 | 2442 |
| 8 | 20 | 2447 |
| 9 | 20 | 2453 |
| 10 | 20 | 2457 |
| 11 | 20 | 2463 |
| 12 | 20 | 2467 |
| 13 | 20 | 2472 |
| 14 (generally not used) | 20 | 2484 |

In order to better understand the embodiments of the present disclosure, the problems solved by the present disclosure are described.

The AMP device (also referred to as the zero-power consumption device or ambient Internet of Things device (Ambient IoT device)) has low-complexity, low-cost, and can be maintenance-free and battery-free. It may be classified into a passive zero-power consumption terminal, a semi-passive zero-power consumption terminal, an active zero-power consumption terminal, or the like, which performs power harvesting on power in the environment (e.g., radio frequency power, light power, thermal power, mechanical power, or kinetic power, etc.) to obtain power for communications. In terms of a communication mode, it may support a backscatter mode and/or an active transmission communication mode.

Due to the need to design and implement the AMP device from a perspective of a low complexity, a low cost and a low-power consumption, the AMP device often cannot maintain a relatively accurate timing, and cannot maintain a small frequency drift and time drift like the traditional terminal device; or, the AMP device cannot maintain an accurate local oscillation signal with a required frequency for a long time (the stability of the frequency cannot be maintained for a long time, and there is a frequency drift). Meanwhile, after the radio frequency signal (RF signal) transmitted from the network device is received, how to down-convert the radio frequency signal to obtain an intermediate frequency (IF) signal for a signal processing in a low-power consumption and low-cost processing mode, is an urgent problem that needs to be solved.

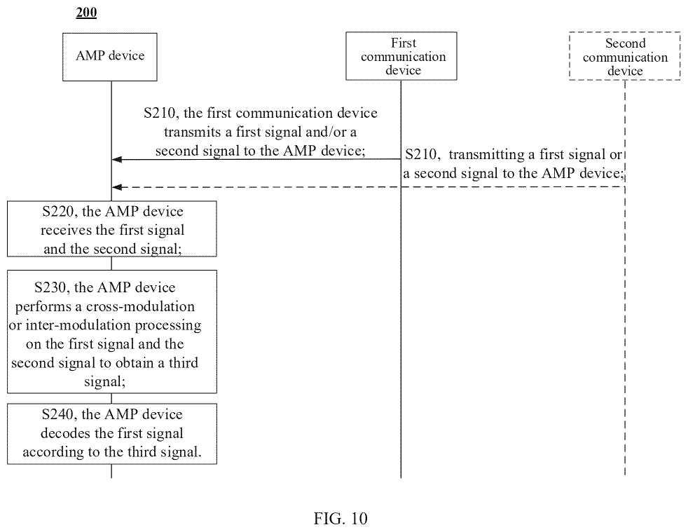

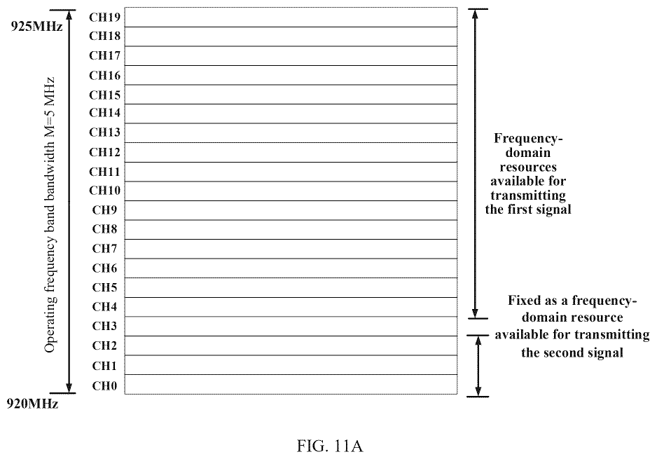

Based on the above problems, in some embodiments of the present disclosure, the principle of cross-modulation/inter-modulation is used to perform cross-modulation/inter-modulation on signals with different frequencies to obtain the required IF signal. For example, when a transmitting end is transmitting a signal, it simultaneously transmits a modulation signal with a center frequency of F1 and a single-carrier signal (Single Tone RF signal) with a (center) frequency of F2, and for example, F1>F2. The AMP device receives the two signals with F1 and F2, and extracts frequency components through a cross-modulation/inter-modulation processing, and for example, extracts a cross-modulation/inter-modulation signal with IM2(F1−F2), as shown in FIG. 9, this signal is equivalent to the IF signal, and then, the AMP device performs a processing such as decoding of the received data based on this signal. That is, in the embodiments of the present disclosure, the AMP device may decode the received signal based on the intermediate frequency signal obtained from the cross-modulation or inter-modulation processing of the two signals with different frequencies, where the AMP device does not need to generate an accurate oscillation signal according to an oscillator (e.g., a crystal oscillator, a digital-controlled oscillator, etc.) to perform a down-conversion processing to obtain a signal for decoding, which can further reduce the power consumption and cost of the AMP device.

In addition, how to transmit signals with different frequencies so that the AMP device may perform inter-modulation/cross-modulation based on the two different signals and extract an equivalent down-converted IF signal, is also an urgent problem that needs to be solved. Based on this problem, the present disclosure proposes a signal transmission scheme, which may transmit two signals (i.e., a first signal and a second signal) respectively on two different candidate frequency-domain resources; or, transmit two signals (i.e., a first signal and a second signal) respectively on different frequency-domain resources in a same candidate frequency-domain resource, and there is a guard period between the frequency-domain resources used to transmit the two signals (i.e., the first signal and the second signal).

In order to understand the technical solutions of the embodiments of the present disclosure, the technical solutions of the present disclosure are described in detail below through exemplary embodiments. The following related technologies may be optional schemes to be arbitrarily combined with the technical solutions of the embodiments of the present disclosure, which all belong to the protection scope of the embodiments of the present disclosure. The embodiments of the present disclosure include at least part of the following contents.

FIG. 10 is a schematic flowchart of a wireless communication method 200 according to the embodiments of the present disclosure. As shown in FIG. 10, the wireless communication method 200 may include at least part of the following contents:
S210, a first communication device transmits a first signal and/or a second signal to an AMP device;
S220, the AMP device receives the first signal and the second signal;
S230, the AMP device performs a cross-modulation or inter-modulation processing on the first signal and the second signal to obtain a third signal; and
S240, the AMP device decodes the first signal according to the third signal.

It should be understood that FIG. 10 shows the steps or operations of the wireless communication method 200, but these steps or operations are merely examples, and the embodiments of the present disclosure may also perform other operations or variations of the operations in FIG. 10.

In the embodiments of the present disclosure, the AMP device may also be referred to as the zero-power consumption device or the ambient Internet of Things device (Ambient IoT device, A-IoT device), which has a simple structure, a low complexity, and a low cost, and is capable of supporting power harvesting for ambient power (e.g., light power, thermal power, radio frequency power, mechanical power, or kinetic power, etc.), to obtain the power required for communications, and may support the backscatter communication mode and/or the active transmission communication mode.

In the embodiments of the present disclosure, the AMP device may be applied to the WiFi and/or cellular networks.

In the embodiments of the present disclosure, the AMP device may decode the first signal according to the third signal obtained from the cross-modulation or inter-modulation processing of the first signal and the second signal, and the AMP device does not need to generate an accurate oscillation signal according to an oscillator (e.g., a crystal oscillator, a digital-controlled oscillator, etc.) to perform a down-conversion processing to obtain a signal for decoding, which can further reduce a power consumption and cost of the AMP device.

In some embodiments, in a case where the first communication device transmits the first signal and the second signal, the first communication device is one of: an access point (AP), a station (STA), a base station, a terminal device, a relay device, or a TRP.

In some embodiments, the first signal and the second signal are transmitted by a same device, or the first signal and the second signal are transmitted by different devices.

In some embodiments, in a case where the first communication device only transmits the first signal, the second signal is transmitted to the AMP device by a second communication device, which is triggered by the first communication device, as shown in FIG. 10. Of course, the second signal may also be actively transmitted by the second communication device, which is not limited in the embodiments of the present disclosure. Optionally, the first communication device is one of: an access point (AP), a station (STA), a base station, a terminal device, a relay device, or a TRP. Optionally, the second communication device is one of: an access point (AP), a station (STA), a base station, a terminal device, a relay device, a TRP, a power supply device for the AMP device, a dedicated device, or a third-party device.

In some embodiments, in a case where the first communication device only transmits the second signal, the second signal is transmitted to the AMP device after a trigger of the second communication device, as shown in FIG. 10. Of course, the second signal may also be actively transmitted by the first communication device, which is not limited in the embodiments of the present disclosure. Optionally, the first communication device is one of: an access point (AP), a station (STA), a base station, a terminal device, a relay device, a TRP, a power supply device for the AMP device, a dedicated device, or a third-party device. Optionally, the second communication device is one of: an access point (AP), a station (STA), a base station, a terminal device, a relay device, or a TRP.

In some embodiments, the first signal carries control information and/or data information. For example, the first information is a radio frequency signal.

In some embodiments, the second signal is a reference radio frequency signal or a dedicated frequency-modulation signal. Of course, the second signal may also be another signal, which is not limited in the present disclosure.

In some embodiments, the third signal is an intermediate frequency (IF) signal. Optionally, the third signal is associated with a high-order component (greater than or equal to a second order, such as a second-order component, a third-order component, a fourth-order component, or other higher-order components) obtained from the cross-modulation or inter-modulation processing of the first signal and the second signal.

For example, the AMP device may directly extract the high-order component(s) obtained from the cross-modulation or inter-modulation processing of the first signal and the second signal. For example, high-order components such as IM2(F_{first signal}−F_{second signal}), IM2(F_{second signal}−F_{first signal}), and IM3(2F_{first signal}−F_{second signal}), etc., are used as the third signal (e.g., the IF signal).

For example, the AMP device obtains the high-order component(s) obtained from the cross-modulation or inter-modulation processing of the first signal and the second signal, and performs a frequency conversion processing on the high-order component obtained from the cross-modulation or inter-modulation processing of the first signal and the second signal to obtain the third signal (e.g., the IF signal). Optionally, the AMP device may perform the frequency conversion processing on the high-order component obtained from the cross-modulation or inter-modulation processing of the first signal and the second signal by an artificial intelligence (AI) model, to obtain the third signal (e.g., the IF signal).

In some embodiments, the second signal is a single-frequency point signal, or the second signal is a multi-frequency point signal.

Optionally, in the embodiments of the present disclosure, a frequency point may be a subcarrier (subcarrier/tone), that is, in the embodiments of the present disclosure, the second signal is a single-subcarrier signal (single tone RF signal/single subcarrier RF signal), or the second signal is a multi-subcarrier signal (multiple tone RF signal/multiple subcarrier RF signal).

In some embodiments, the second signal is a narrowband signal with a bandwidth less than or equal to a preset value. Optionally, the preset value is specified by a protocol, or the preset value is configured (semi-statically or dynamically configured) by a network device (e.g., an AP or a base station, or a TRP), or the preset value is determined based on information reported by the AMP device.

In some embodiments, the AMP device performs power harvesting based on the first signal and/or the second signal.

In some embodiments, the second signal is a signal transmitted periodically. Optionally, period information for transmitting the second signal may be specified by a protocol, or the period information for transmitting the second signal may be configured (semi-statically or dynamically configured) by a network device (e.g., an AP or a base station, or a TRP), or the period information for transmitting the second signal may be determined based on information reported by the AMP device.

In some embodiments, the second signal is a signal transmitted based on an event trigger. For example, when data needs to be transmitted to the AMP device, the second signal is transmitted (in this case, a starting transmission time of the second signal may be earlier than, equal to, or lagged behind a starting transmission time of the first signal).

In some embodiments, the second signal is a signal transmitted with being bound to the first signal (i.e., the second signal and the first signal exist simultaneously).

In some embodiments, the second signal is a signal transmitted continuously.

In some embodiments, a center frequency point of the first signal is different from a center frequency point of the second signal; and/or a center frequency point of a frequency-domain resource used for transmitting the first signal is different from a center frequency point of a frequency-domain resource used for transmitting the second signal.

In some embodiments, the candidate frequency-domain resource is one of: a channel, a system bandwidth, a carrier bandwidth, a bandwidth part (BWP), an aggregation/set/binding of a plurality of BWPs, an aggregation/set/binding of a plurality of subcarriers, or an aggregation/set/binding of a plurality of physical resource blocks (PRBs).

In some embodiments, a frequency-domain resource used for transmitting the first signal is a/one candidate frequency-domain resource, or a frequency-domain resource used for transmitting the first signal is a portion of a/one candidate frequency-domain resource. For example, the candidate frequency-domain resource is a channel, and the frequency-domain resource used for transmitting the first signal is some subcarriers in a/one channel.

In some embodiments, a frequency-domain resource used for transmitting the second signal is a/one candidate frequency-domain resource, or a frequency-domain resource used for transmitting the second signal is a portion of a/one candidate frequency-domain resource. For example, the candidate frequency-domain resource is a channel, and the frequency-domain resource used for transmitting the second signal is one or more subcarriers in a/one channel.

In some embodiments, within a deployment frequency band corresponding to the AMP device, different candidate frequency-domain resources do not overlap with each other, or different candidate frequency-domain resources partially overlap with each other.

For example, the AMP device may be applied to a cellular system, and may also be applied to a WiFi system. Within the deployment operating frequency band of the AMP device, a plurality of channels or carriers may often be divided, and different channels may overlap or not overlap with each other. The first communication device and/or the second communication device may transmit the first signal and the second signal on a same candidate frequency-domain resource or two different candidate frequency-domain resources on its operating frequency band, and correspondingly, the AMP device may receive the first signal and the second signal on a same candidate frequency-domain resource or two different candidate frequency-domain resources on its operating frequency band, to obtain the third signal (i.e., the IF signal corresponding to the first signal) directly or indirectly through cross-modulation/inter-modulation, so as to decode the first signal.

For example, in a case where the AMP device communicates by using of an RFID frequency band of 920 to 925 MHz, and each channel bandwidth is 250 kHz, a system bandwidth of 5 MHz (920 to 925 MHz) may be divided into 20 channels with a bandwidth of 250 kHz. In this case, the candidate frequency-domain resource may be a channel, that is, each channel serves as one/a candidate frequency-domain resource, and the AMP device may receive the first signal and the second signal on different channels.

In some embodiments, the candidate frequency-domain resource used for transmitting the first signal is different from the candidate frequency-domain resource used for transmitting the second signal, or the candidate frequency-domain resource used for transmitting the first signal is same as the candidate frequency-domain resource used for transmitting the second signal.

In some embodiments, in a case where the candidate frequency-domain resource used for transmitting the first signal is different from the candidate frequency-domain resource used for transmitting the second signal, all candidate frequency-domain resources within a deployment frequency band corresponding to the AMP device include m first-type candidate frequency-domain resources and n second-type candidate frequency-domain resources, where the first-type candidate frequency-domain resources are candidate frequency-domain resources that are available for transmitting the first signal, and the second-type candidate frequency-domain resources are candidate frequency-domain resources that are available for transmitting the second signal, and m and n are both positive integers.

For example, m=1,2,3, . . . ; and/or, n=1, 2, 3 . . . .

For example, in a case where the RFID frequency band of 920 to 925 MHz is used for communications, and each channel bandwidth is 250 kHz, the system bandwidth of 5 MHz (920 to 925 MHz) may be divided into 20 channels with a bandwidth of 250 kHz. In this case, the candidate frequency-domain resource may refer to each channel with 250 kHz, that is, each channel serves as one/a candidate frequency-domain resource, and the transmitting end transmits the first signal and the second signal on two different channels respectively. For example, a same transmitting end transmits two RF signals (i.e., the first signal and the second signal), or two transmitting ends transmit two RF signals (i.e., the first signal and the second signal) respectively.

In some embodiments, the m first-type candidate frequency-domain resources are all candidate frequency-domain resources except the n second-type candidate frequency-domain resources within the deployment frequency band corresponding to the AMP device.

For example, among all candidate channels within the deployment frequency band, one/a channel may be used to transmit the second signal; and remaining channels may be used to transmit the first signal.

In some embodiments, the second-type candidate frequency-domain resources within the deployment frequency band corresponding to the AMP device are not available for transmitting a signal other than the second signal. Thus, a reliable transmission of the second signal may be ensured.

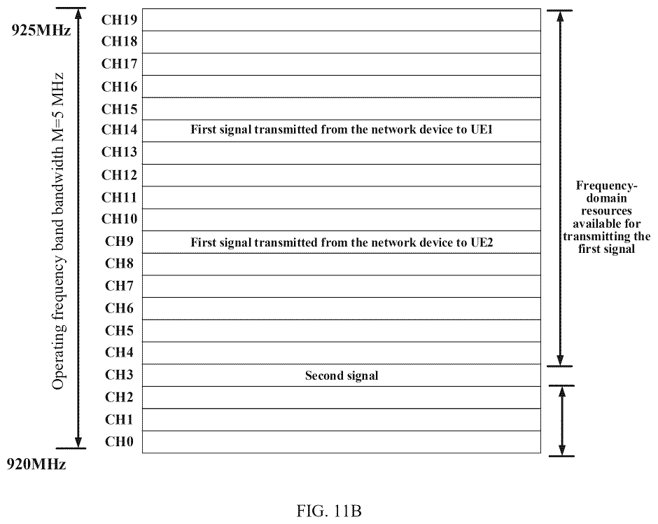

For example, in a case where the RFID frequency band of 920 to 925 MHz is used for communications, and each channel bandwidth is 250 kHz, the system bandwidth of 5 MHz (920 to 925 MHz) may be divided into 20 channels (CH) with a bandwidth of 250 kHz. As shown in FIG. 11A and FIG. 11B, the frequency-domain resource available for transmitting the second signal is fixed as CH3 (i.e., the second-type candidate frequency-domain resource is CH3), and remaining 19 channels are available for transmitting the first signal (i.e., the first-type candidate frequency-domain resources are the remaining 19 channels except CH3). In FIG. 11B, the network device transmits the second signal to UE1 and UE2 by using CH3, the network device transmits the first signal to UE1 by using CH14, and the network device transmits the first signal to UE2 by using CH9. That is, different UEs (i.e., AMP devices) share the frequency-domain resource (i.e., CH3) available for transmitting the second signal.

In some embodiments, an interval between a center frequency point of the candidate frequency-domain resource used for transmitting the first signal and a center frequency point of the candidate frequency-domain resource used for transmitting the second signal is greater than or equal to X₁ frequency-domain units, and/or an interval between a center frequency point of the first signal and a center frequency point of the second signal is greater than or equal to X₁ frequency-domain units, and X₁ is a positive integer.

For example, in a case where n=1, an interval between a center frequency point of the candidate frequency-domain resource used for transmitting the first signal and a center frequency point of the candidate frequency-domain resource used for transmitting the second signal is greater than or equal to X₁ frequency-domain units, and/or an interval between a center frequency point of the first signal and a center frequency point of the second signal is greater than or equal to X₁ frequency-domain units, and X₁ is a positive integer.

In some embodiments, a frequency-domain unit in the X₁ frequency-domain units is one of: a candidate frequency-domain resource, a channel, a system bandwidth, a carrier, a subcarrier, a PRB, a BWP, megahertz (MHz), kilohertz (kHz), or hertz (Hz).

In some embodiments, the X₁ frequency-domain units are specified by a protocol, or the X₁ frequency-domain units are configured (semi-statically or dynamically configured) by a network device (e.g., an AP or a base station, or a TRP), or the X₁ frequency-domain units are determined based on a frequency hopping factor recommended by the AMP device.

In some embodiments, each of the second-type candidate frequency-domain resources within the deployment frequency band corresponding to the AMP device is associated with a set of first-type candidate frequency-domain resources in the first-type candidate frequency-domain resources in the deployment frequency band corresponding to the AMP device.

For example, in a case where n>2, each of the second-type candidate frequency-domain resources within the deployment frequency band corresponding to the AMP device is associated with a set of first-type candidate frequency-domain resources in the first-type candidate frequency-domain resources in the deployment frequency band corresponding to the AMP device.

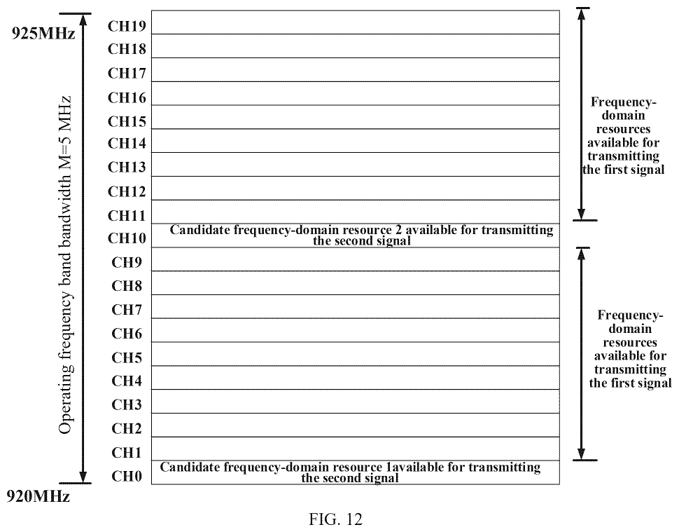

For example, in the case where the RFID frequency band of 920 to 925 MHz is used for communications, and each channel bandwidth is 250 kHz, the system bandwidth of 5 MHz (920 to 925 MHz) may be divided into 20 channels (CH) with a bandwidth of 250 kHz. As shown in FIG. 12, the frequency-domain resources available for transmitting the second signal are CH0 and CH10 (i.e., the second-type candidate frequency-domain resources are CH0 and CH10), and the frequency-domain resources available for transmitting the first signal are CH1 to CH9 and CH11 to CH19 (i.e., the first-type candidate frequency-domain resources are CH1 to CH9 and CH11 to CH19). CH0 available for transmitting the second signal is associated with CH1 to CH9 available for transmitting the first signal, and CH10 available for transmitting the second signal is associated with CH11 to CH19 available for transmitting the first signal.

In some embodiments, an association relationship between the first-type candidate frequency-domain resources and the second-type candidate frequency-domain resources is specified by a protocol, or an association relationship between the first-type candidate frequency-domain resources and the second-type candidate frequency-domain resources is configured (semi-statically or dynamically configured) by a network device (e.g., an AP or a base station, or a TRP), or an association relationship between the first-type candidate frequency-domain resources and the second-type candidate frequency-domain resources is determined based on information reported by the AMP device.

In some embodiments, the deployment frequency band corresponding to the AMP device includes a plurality of sets of bound candidate frequency-domain resources; where each set of bound candidate frequency-domain resources in the plurality of sets of bound candidate frequency-domain resources includes at least one of the first-type candidate frequency-domain resources and at least one of the second-type candidate frequency-domain resources.

For example, in a case where n>2, the deployment frequency band corresponding to the AMP device includes a plurality of sets of bound candidate frequency-domain resources; where each set of bound candidate frequency-domain resources in the plurality of sets of bound candidate frequency-domain resources includes at least one of the first-type candidate frequency-domain resources and at least one of the second-type candidate frequency-domain resources.

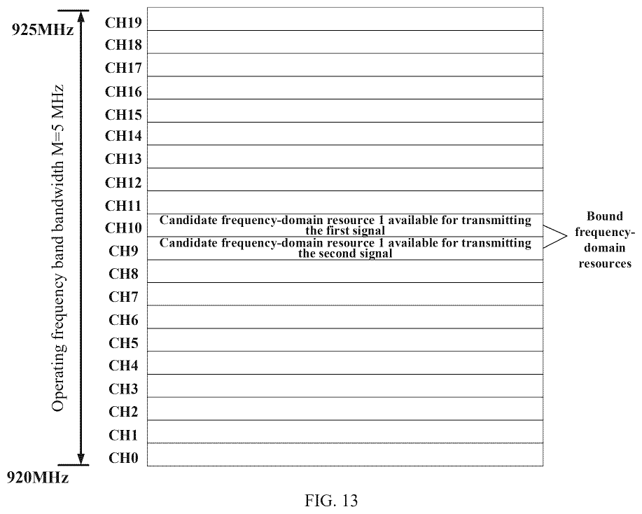

For example, in a case where the RFID frequency band of 920 to 925 MHz is used for communications, and each channel bandwidth is 250 kHz, the system bandwidth of 5 MHz (920 to 925 MHz) may be divided into 20 channels (CH) with a bandwidth of 250 kHz. As shown in FIG. 13, the frequency-domain resource available for transmitting the first signal is CH10 (i.e., the first-type candidate frequency-domain resource is CH10), and the frequency-domain resource available for transmitting the second signal is CH9 (i.e., the second-type candidate frequency-domain resource is CH9), where CH9 available for transmitting the second signal and CH10 available for transmitting the first signal are two different channels that are bound.

In some embodiments, the plurality of sets of bound candidate frequency-domain resources are specified by a protocol, or the plurality of sets of bound candidate frequency-domain resources are configured (semi-statically or dynamically configured) by a network device (e.g., an AP or a base station, or a TRP), or the plurality of sets of bound candidate frequency-domain resources are determined based on information reported by the AMP device.

In some embodiments, in a case where the plurality of sets of bound candidate frequency-domain resources are configured by the network device, the plurality of sets of bound candidate frequency-domain resources are preempted and indicated to the AMP device by the network device, or the plurality of sets of bound candidate frequency-domain resources are semi-statically or dynamically configured by the network device.

In some embodiments, in each set of bound candidate frequency-domain resources in the plurality of sets of bound candidate frequency-domain resources, the first-type candidate frequency-domain resource is adjacent to the second-type candidate frequency-domain resource, or the first-type candidate frequency-domain resource is not adjacent to the second-type candidate frequency-domain resource.

For example, each set of bound candidate frequency-domain resources includes two different channels that are bound, which may be two adjacent channels or two non-adjacent channels.

In some embodiments, in each set of bound candidate frequency-domain resources in the plurality of sets of bound candidate frequency-domain resources, the first-type candidate frequency-domain resource and the second-type candidate frequency-domain resource satisfy a preset relationship. Optionally, the preset relationship may be specified by a protocol, or the preset relationship may be configured (semi-statically or dynamically configured) by a network device (e.g., an AP or a base station, or a TRP).

In some embodiments, in each set of bound candidate frequency-domain resources in the plurality of sets of bound candidate frequency-domain resources, the first-type candidate frequency-domain resource and the second-type candidate frequency-domain resource satisfy the following Equation 1:

$${F}_{1} = {F}_{2} + Δ F \qquad Equation 1$$

where F₁ represents the first-type candidate frequency-domain resource, F₂ represents the second-type candidate frequency-domain resource, and ΔF represents a frequency-domain interval.

Optionally, ΔF may be specified by a protocol, or ΔF may be configured (semi-statically or dynamically configured) by a network device (e.g., an AP or a base station, or a TRP).

In some embodiments, the m first-type candidate frequency-domain resources are configured (semi-statically or dynamically configured) by a network device (e.g., an AP or a base station, or a TRP). Optionally, a configuration granularity of the m first-type candidate frequency-domain resources includes one of: an AMP granularity, an AMP group granularity, or a cell granularity. For example, in a case where the configuration granularity of the m first-type candidate frequency-domain resources is the cell granularity, the m first-type candidate frequency-domain resources are configured in a broadcast mode.

In some embodiments, the m first-type candidate frequency-domain resources are preempted and indicated to the AMP device by a network device (e.g., an AP or a base station, or a TRP).

In some embodiments, the m first-type candidate frequency-domain resources are determined based on information reported by the AMP device.

In some embodiments, the m first-type candidate frequency-domain resources are associated with at least one of: an identifier of the AMP device, or an identifier of an AMP group to which the AMP device belongs.

For example, assuming that the deployment frequency band corresponding to the AMP device contains W candidate frequency-domain resources, the first-type candidate frequency-domain resources are determined based on ID mod W, where ID is an identifier of the AMP device, or ID is an identifier of an AMP group to which the AMP device belongs, or ID is an identifier determined based on the identifier of the AMP device and the identifier of the AMP group to which the AMP device belongs (an identifier obtained by truncating some fields of the identifier of the AMP device and the identifier of the AMP group to which the AMP device belongs).

In some embodiments, a frequency-domain resource in the first-type candidate frequency-domain resources that is available for transmitting the first signal is configured (semi-statically or dynamically configured) by a network device (e.g., an AP or a base station, or a TRP), or, a frequency-domain resource in the first-type candidate frequency-domain resources that is available for transmitting the first signal is specified by a protocol, or, a frequency-domain resource in the first-type candidate frequency-domain resources that is available for transmitting the first signal is determined based on information reported by the AMP device.

For example, the first-type candidate frequency-domain resource is a channel, and the frequency-domain resource available for transmitting the first signal is one or more subcarriers or frequency points (subcarriers/tones). For example, the frequency-domain resource available for transmitting the first signal may be located at an upper side, a middle side, or a lower side of the channel, or a position specified by a protocol, etc.

In some embodiments, in a case where the frequency-domain resource in the first-type candidate frequency-domain resources that is available for transmitting the first signal is configured by the network device, a configuration granularity of the frequency-domain resource in the first-type candidate frequency-domain resources that is available for transmitting the first signal includes one of: an AMP granularity, an AMP group granularity, or a cell granularity.

In some embodiments, the n second-type candidate frequency-domain resources are specified by a protocol.

In some embodiments, the n second-type candidate frequency-domain resources are configured (semi-statically or dynamically configured) by a network device (e.g., an AP or a base station, or a TRP). Optionally, a configuration granularity of the n second-type candidate frequency-domain resources includes one of: an AMP granularity, an AMP group granularity, or a cell granularity. For example, in the case where the configuration granularity of the n second-type candidate frequency-domain resources is the cell granularity, the n second-type candidate frequency-domain resources are configured in a broadcast mode.

In some embodiments, the n second-type candidate frequency-domain resources are determined based on information reported by the AMP device.

In some embodiments, the n second-type candidate frequency-domain resources are preempted and indicated to the AMP device by a network device.

In some embodiments, a frequency-domain resource in the second-type candidate frequency-domain resource that is available for transmitting the second signal is configured (semi-statically or dynamically configured) by a network device (e.g., an AP or a base station, or a TRP), or, a frequency-domain resource in the second-type candidate frequency-domain resource that is available for transmitting the second signal is specified by a protocol, or, a frequency-domain resource in the second-type candidate frequency-domain resource that is available for transmitting the second signal is determined based on information reported by the AMP device.

For example, the second-type candidate frequency-domain resource is a channel, and the frequency-domain resource available for transmitting the second signal is one subcarrier/tone. For example, the frequency-domain resource available for transmitting the second signal may be located at an upper side, a middle side, or a lower side of the channel, or a position specified by a protocol, etc.

In some embodiments, in a case where the frequency-domain resource in the second-type candidate frequency-domain resources that is available for transmitting the second signal is configured by the network device, a configuration granularity of the frequency-domain resource in the second-type candidate frequency-domain resources that is available for transmitting the second signal includes one of: an AMP granularity, an AMP group granularity, or a cell granularity. For example, in a case where the configuration granularity of the frequency-domain resource in the second-type candidate frequency-domain resources that is available for transmitting the second signal is the cell granularity, the frequency-domain resource in the second-type candidate frequency-domain resources that is available for transmitting the second signal is configured in a broadcast mode.

In some embodiments, different AMP devices share a candidate frequency-domain resource that is available for transmitting the second signal, or different AMP devices use different candidate frequency-domain resources that are available for transmitting the second signal.

In some embodiments, in a case where the different AMP devices share the candidate frequency-domain resource that is available for transmitting the second signal, the different AMP devices transmit the second signal by using a frequency-division multiplexing (FDM) mode.

In some embodiments, in a case where the candidate frequency-domain resource used for transmitting the first signal is same as the candidate frequency-domain resource used for transmitting the second signal, all candidate frequency-domain resources within the deployment frequency band corresponding to the AMP device includes third-type candidate frequency-domain resources, where the third-type candidate frequency-domain resources are candidate frequency-domain resources that are available for transmitting the first signal and the second signal, and s is a positive integer. For example, s=1, 2, 3, . . . .

In some embodiments, a frequency-domain resource in the third-type candidate frequency-domain resources that is available for transmitting the first signal is different from a frequency-domain resource in the third-type candidate frequency-domain resources that is available for transmitting the second signal.

In some embodiments, an interval between a frequency-domain resource in the third-type candidate frequency-domain resources that is available for transmitting the first signal and a frequency-domain resource in the third-type candidate frequency-domain resources that is available for transmitting the second signal is greater than or equal to X₂ frequency-domain units, and X₂ is a positive integer.

In some embodiments, a frequency-domain unit in the X₂ frequency-domain units is one of: a channel, a system bandwidth, a carrier, a subcarrier, a PRB, a BWP, MHz, kHz, or Hz.

In some embodiments, the X₂ frequency-domain units are specified by a protocol, or the X₂ frequency-domain units are configured (semi-statically or dynamically configured) by a network device (e.g., an AP or a base station, or a TRP), or the X₂ frequency-domain units are determined based on a frequency hopping factor recommended by the AMP device.

In some embodiments, there are guard periods on both sides of a frequency-domain resource in the third-type candidate frequency-domain resources that is available for transmitting the second signal, where the guard periods are not available for transmitting a radio frequency signal. Optionally, the guard period may be the X₂ frequency-domain units, or the guard period may be smaller than the X₂ frequency-domain units. Thus, the interference of a transmission of another radio frequency signal to the transmission of the second signal may be avoided, thereby ensuring a reliable transmission of the second signal.

In some embodiments, sizes of the guard periods on both sides of the frequency-domain resource in the third-type candidate frequency-domain resources that is available for transmitting the second signal are same, or sizes of the guard periods on both sides of the frequency-domain resource in the third-type candidate frequency-domain resources that is available for transmitting the second signal are different. Thus, the guard periods on both sides of the frequency-domain resource available for transmitting the second signal may be set more flexibly.

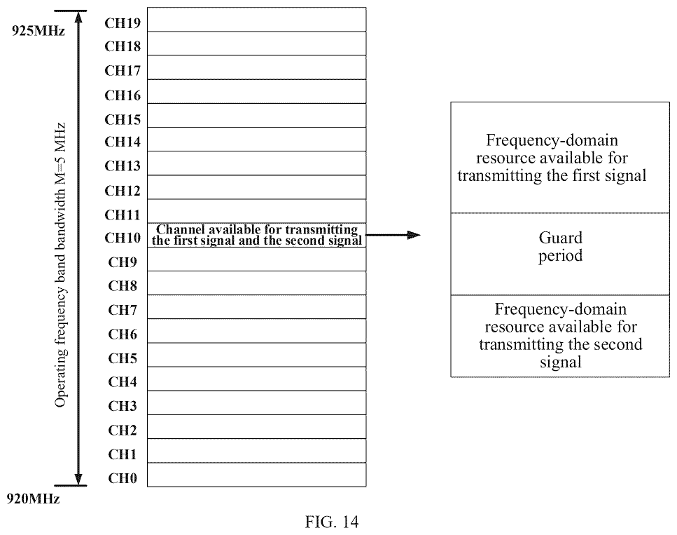

For example, in the case where the RFID frequency band of 920 to 925 MHz is used for communications, and each channel bandwidth is 250 kHz, the system bandwidth of 5 MHz (920 to 925 MHz) may be divided into 20 channels (CH) with a bandwidth of 250 kHz. As shown in FIG. 14, the candidate frequency-domain resource available for transmitting the first signal and the second signal is CH10 (i.e., the third-type candidate frequency-domain resource is CH10). In CH10, there is a guard period (GAP) between the frequency-domain resource available for transmitting the first signal and the frequency-domain resource available for transmitting the second signal.

In some embodiments, the third-type candidate frequency-domain resources are configured (semi-statically or dynamically configured) by a network device (e.g., an AP or a base station, or a TRP).

In some embodiments, the third-type candidate frequency-domain resources are determined based on information reported by the AMP device.

In some embodiments, the third-type candidate frequency-domain resources are preempted and indicated to the AMP device by a network device.

In some embodiments, in a case where the third-type candidate frequency-domain resources are preempted and indicated to the AMP device by the network device, the third-type candidate frequency-domain resources are successfully preempted in a case where in the third-type candidate frequency-domain resources, there is no interference in a frequency-domain resource available for transmitting the first signal, in a frequency-domain resource available for transmitting the second signal, and between the frequency-domain resource available for transmitting the first signal and the frequency-domain resource available for transmitting the second signal.

In some embodiments, in a case where the third-type candidate frequency-domain resources are preempted and indicated to the AMP device by the network device, the network device may preempt the resources through a scheme similar to a transmission opportunity (TXOP) mechanism.

In some embodiments, in a case where the third-type candidate frequency-domain resources are preempted and indicated to the AMP device by the network device, the third-type candidate frequency-domain resources and candidate frequency-domain resources adjacent to the third-type candidate frequency-domain resources are both preempted by the network device, or only the third-type candidate frequency-domain resources are preempted by the network device.

In some embodiments, a frequency-domain resource in the third-type candidate frequency-domain resource that is available for transmitting the first signal is configured (semi-statically or dynamically configured) by a network device (e.g., an AP or a base station, or a TRP), or a frequency-domain resource in the third-type candidate frequency-domain resources that is available for transmitting the first signal is specified by a protocol, or a frequency-domain resource in the third-type candidate frequency-domain resources that is available for transmitting the first signal is determined based on information reported by the AMP device.

For example, the third-type candidate frequency-domain resource is a channel, and the frequency-domain resource available for transmitting the first signal is one or more subcarriers or frequency points (subcarriers/tones). For example, the frequency-domain resource available for transmitting the first signal may be located at an upper side, a middle side, or a lower side of the channel, or a position specified by a protocol, etc.

In some embodiments, a frequency-domain resource in the third-type candidate frequency-domain resources that is available for transmitting the second signal is configured (semi-statically or dynamically configured) by a network device (e.g., an AP or a base station, or a TRP), or a frequency-domain resource in the third-type candidate frequency-domain resources that is available for transmitting the second signal is specified by a protocol, or a frequency-domain resource in the third-type candidate frequency-domain resources that is available for transmitting the second signal is determined based on information reported by the AMP device.

For example, the third-type candidate frequency-domain resource is a channel, and the frequency-domain resource available for transmitting the second signal is one subcarrier/tone. For example, the frequency-domain resource available for transmitting the second signal may be located at an upper side, a middle side, or a lower side of the channel, or a position specified by a protocol, etc.

In some embodiments, in the third-type candidate frequency-domain resources, a frequency-domain resource that is available for transmitting the first signal is located before a frequency-domain resource that is available for transmitting the second signal, or, in the third-type candidate frequency-domain resources, a frequency-domain resource that is available for transmitting the first signal is located after a frequency-domain resource that is available for transmitting the second signal.

In some embodiments, in a case where the frequency-domain resource in the third-type candidate frequency-domain resources that is available for transmitting the first signal is configured by the network device, a configuration granularity of the frequency-domain resource in the third-type candidate frequency-domain resources that is available for transmitting the first signal includes one of: an AMP granularity, an AMP group granularity, or a cell granularity. For example, in a case where the configuration granularity of the frequency-domain resource in the third-type candidate frequency-domain resources that is available for transmitting the first signal is the cell granularity, the frequency-domain resource in the third-type candidate frequency-domain resources that is available for transmitting the first signal is configured in a broadcast mode.

In some embodiments, in a case where the frequency-domain resource in the third-type candidate frequency-domain resources that is available for transmitting the second signal is configured by the network device, a configuration granularity of the frequency-domain resource in the third-type candidate frequency-domain resources that is available for transmitting the second signal includes one of: an AMP granularity, an AMP group granularity, or a cell granularity. For example, in the case where the configuration granularity of the frequency-domain resource in the third-type candidate frequency-domain resources that is available for transmitting the second signal is the cell granularity, the frequency-domain resource in the third-type candidate frequency-domain resources that is available for transmitting the second signal is configured in a broadcast mode.

In some embodiments, different AMP devices share a candidate frequency-domain resource that is available for transmitting the second signal, or different AMP devices use different candidate frequency-domain resources that are available for transmitting the second signal.

In some embodiments, in a case where the different AMP devices share the candidate frequency-domain resource that is available for transmitting the second signal, the different AMP devices transmit the second signal by using an FDM mode.

Therefore, in the embodiments of the present disclosure, the AMP device may decode a first signal according to a third signal obtained from a cross-modulation or inter-modulation processing of the first signal and a second signal, and the AMP device does not need to generate an accurate oscillation signal according to an oscillator (e.g., a crystal oscillator, a digital-controlled oscillator, etc.) to perform a down-conversion processing to obtain a signal for decoding, which can further reduce a power consumption and cost of the AMP device.

That is, in the embodiments of the present disclosure, in a case where the transmitting end communicates with the AMP device, the first signal (transmission data or control information) and the second signal (single-tone RF signal) may be transmitted simultaneously; the AMP device, after receiving the two RF signals, performs cross-modulation/inter-modulation on the two signals, and obtains an IF signal corresponding to the first signal based on frequency components of the cross-modulation/inter-modulation, such as IM2(F1−F2), and then performs the decoding processing. By using this method, the AMP device does not need to generate an accurate oscillation signal according to an oscillator (e.g., a crystal oscillator, a digital-controlled oscillator, etc.) to perform a down-conversion processing to obtain an IF signal, which can further reduce the power consumption and cost of the AMP device.

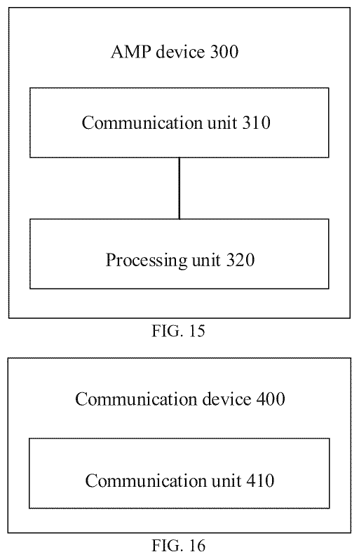

The method embodiments of the present disclosure are described in detail above with reference to FIG. 10 to FIG. 14, and apparatus embodiments of the present disclosure are described in detail below with reference to FIG. 15 to FIG. 19. It should be understood that the apparatus embodiments and the method embodiments correspond to each other, and similar descriptions may refer to the method embodiments.

FIG. 15 shows a schematic block diagram of an ambient power (AMP) device 300 according to the embodiments of the present disclosure. As shown in FIG. 15, the AMP device 300 includes:
a communication unit 310, configured to receive a first signal and a second signal;
a processing unit 320, configured to perform a cross-modulation or inter-modulation processing on the first signal and the second signal to obtain a third signal; and
the processing unit 320, further configured to decode the first signal according to the third signal.

In some embodiments, a center frequency point of the first signal is different from a center frequency point of the second signal; and/or a center frequency point of a frequency-domain resource used for transmitting the first signal is different from a center frequency point of a frequency-domain resource used for transmitting the second signal.

In some embodiments, a frequency-domain resource used for transmitting the first signal is a candidate frequency-domain resource, or a frequency-domain resource used for transmitting the first signal is a portion of a candidate frequency-domain resource; and/or
a frequency-domain resource used for transmitting the second signal is a candidate frequency-domain resource, or a frequency-domain resource used for transmitting the second signal is a portion of a candidate frequency-domain resource.

In some embodiments, the candidate frequency-domain resource used for transmitting the first signal is different from the candidate frequency-domain resource used for transmitting the second signal, or the candidate frequency-domain resource used for transmitting the first signal is same as the candidate frequency-domain resource used for transmitting the second signal.

In some embodiments, in a case where the candidate frequency-domain resource used for transmitting the first signal is different from the candidate frequency-domain resource used for transmitting the second signal, all candidate frequency-domain resources within a deployment frequency band corresponding to the AMP device include m first-type candidate frequency-domain resources and n second-type candidate frequency-domain resources, where the first-type candidate frequency-domain resources are candidate frequency-domain resources that are available for transmitting the first signal, and the second-type candidate frequency-domain resources are candidate frequency-domain resources that are available for transmitting the second signal, and m and n are both positive integers.

In some embodiments, the m first-type candidate frequency-domain resources are all candidate frequency-domain resources except the n second-type candidate frequency-domain resources within the deployment frequency band corresponding to the AMP device.

In some embodiments, the second-type candidate frequency-domain resources within the deployment frequency band corresponding to the AMP device are not available for transmitting a signal other than the second signal.

In some embodiments, in a case where n=1, an interval between a center frequency point of the candidate frequency-domain resource used for transmitting the first signal and a center frequency point of the candidate frequency-domain resource used for transmitting the second signal is greater than or equal to X₁ frequency-domain units, and/or an interval between a center frequency point of the first signal and a center frequency point of the second signal is greater than or equal to X₁ frequency-domain units, and X₁ is a positive integer.

In some embodiments, a frequency-domain unit in the X₁ frequency-domain units is one of: a candidate frequency-domain resource, a channel, a system bandwidth, a carrier, a subcarrier, a physical resource block (PRB), a bandwidth part (BWP), megahertz (MHz), kilohertz (kHz), or hertz (Hz).

In some embodiments, in a case where n>2, each of the second-type candidate frequency-domain resources within the deployment frequency band corresponding to the AMP device is associated with a set of first-type candidate frequency-domain resources in the first-type candidate frequency-domain resources in the deployment frequency band corresponding to the AMP device.

In some embodiments, an association relationship between the first-type candidate frequency-domain resources and the second-type candidate frequency-domain resources is specified by a protocol, or an association relationship between the first-type candidate frequency-domain resources and the second-type candidate frequency-domain resources is configured by a network device, or an association relationship between the first-type candidate frequency-domain resources and the second-type candidate frequency-domain resources is determined based on information reported by the AMP device.

In some embodiments, in a case where n>2, the deployment frequency band corresponding to the AMP device includes a plurality of sets of bound candidate frequency-domain resources; where each set of bound candidate frequency-domain resources in the plurality of sets of bound candidate frequency-domain resources includes at least one of the first-type candidate frequency-domain resources and at least one of the second-type candidate frequency-domain resources.

In some embodiments, the plurality of sets of bound candidate frequency-domain resources are specified by a protocol, or the plurality of sets of bound candidate frequency-domain resources are configured by a network device, or the plurality of sets of bound candidate frequency-domain resources are determined based on information reported by the AMP device.

In some embodiments, in a case where the plurality of sets of bound candidate frequency-domain resources are configured by the network device, the plurality of sets of bound candidate frequency-domain resources are preempted and indicated to the AMP device by the network device, or the plurality of sets of bound candidate frequency-domain resources are semi-statically or dynamically configured by the network device.

In some embodiments, in each set of bound candidate frequency-domain resources in the plurality of sets of bound candidate frequency-domain resources, the first-type candidate frequency-domain resource is adjacent to the second-type candidate frequency-domain resource, or the first-type candidate frequency-domain resource is not adjacent to the second-type candidate frequency-domain resource.

In some embodiments, in each set of bound candidate frequency-domain resources in the plurality of sets of bound candidate frequency-domain resources, the first-type candidate frequency-domain resource and the second-type candidate frequency-domain resource satisfy a preset relationship.

In some embodiments, in each set of bound candidate frequency-domain resources in the plurality of sets of bound candidate frequency-domain resources, the first-type candidate frequency-domain resource and the second-type candidate frequency-domain resource satisfy an equation:

$${F}_{1} = {F}_{2} + Δ F ;$$

where F₁ represents the first-type candidate frequency-domain resource, F₂ represents the second-type candidate frequency-domain resource, and ΔF represents a frequency-domain interval.

In some embodiments, the m first-type candidate frequency-domain resources are configured by a network device; or
the m first-type candidate frequency-domain resources are preempted and indicated to the AMP device by a network device; or
the m first-type candidate frequency-domain resources are determined based on information reported by the AMP device; or
the m first-type candidate frequency-domain resources are associated with at least one of: an identifier of the AMP device, or an identifier of an AMP group to which the AMP device belongs.

In some embodiments, in a case where the m first-type candidate frequency-domain resources are configured by the network device, a configuration granularity of the m first-type candidate frequency-domain resources includes one of: an AMP granularity, an AMP group granularity, or a cell granularity.

In some embodiments, a frequency-domain resource in the first-type candidate frequency-domain resources that is available for transmitting the first signal is configured by a network device, or a frequency-domain resource in the first-type candidate frequency-domain resources that is available for transmitting the first signal is specified by a protocol, or a frequency-domain resource in the first-type candidate frequency-domain resources that is available for transmitting the first signal is determined based on information reported by the AMP device.

In some embodiments, in a case where the frequency-domain resource in the first-type candidate frequency-domain resources that is available for transmitting the first signal is configured by the network device, a configuration granularity of the frequency-domain resource in the first-type candidate frequency-domain resources that is available for transmitting the first signal includes one of: an AMP granularity, an AMP group granularity, or a cell granularity.

In some embodiments, the n second-type candidate frequency-domain resources are specified by a protocol; or
the n second-type candidate frequency-domain resources are configured by a network device; or
the n second-type candidate frequency-domain resources are determined based on information reported by the AMP device; or
the n second-type candidate frequency-domain resources are preempted and indicated to the AMP device by a network device.

In some embodiments, in a case where the n second-type candidate frequency-domain resources are configured by the network device, a configuration granularity of the n second-type candidate frequency-domain resources includes one of: an AMP granularity, an AMP group granularity, or a cell granularity.

In some embodiments, a frequency-domain resource in the second-type candidate frequency-domain resources that is available for transmitting the second signal is configured by a network device, or a frequency-domain resource in the second-type candidate frequency-domain resources that is available for transmitting the second signal is specified by a protocol, or a frequency-domain resource in the second-type candidate frequency-domain resources that is available for transmitting the second signal is determined based on information reported by the AMP device.

In some embodiments, in a case where the frequency-domain resource in the second-type candidate frequency-domain resources that is available for transmitting the second signal is configured by the network device, a configuration granularity of the frequency-domain resource in the second-type candidate frequency-domain resources that is available for transmitting the second signal includes one of: an AMP granularity, an AMP group granularity, or a cell granularity.

In some embodiments, in a case where the candidate frequency-domain resource used for transmitting the first signal is same as the candidate frequency-domain resource used for transmitting the second signal, all candidate frequency-domain resources within the deployment frequency band corresponding to the AMP device includes third-type candidate frequency-domain resources, where the third-type candidate frequency-domain resources are candidate frequency-domain resources that are available for transmitting the first signal and the second signal, and s is a positive integer.

In some embodiments, a frequency-domain resource in the third-type candidate frequency-domain resources that is available for transmitting the first signal is different from a frequency-domain resource in the third-type candidate frequency-domain resources that is available for transmitting the second signal.

In some embodiments, an interval between a frequency-domain resource in the third-type candidate frequency-domain resources that is available for transmitting the first signal and a frequency-domain resource in the third-type candidate frequency-domain resources that is available for transmitting the second signal is greater than or equal to X₂ frequency-domain units, and X₂ is a positive integer.

In some embodiments, a frequency-domain unit in the X₂ frequency-domain units is one of: a channel, a system bandwidth, a carrier, a subcarrier, a PRB, a BWP, MHz, kHz, or Hz.

In some embodiments, there are guard periods on both sides of a frequency-domain resource in the third-type candidate frequency-domain resources that is available for transmitting the second signal, where the guard periods are not available for transmitting a radio frequency signal.

In some embodiments, sizes of the guard periods on both sides of the frequency-domain resource in the third-type candidate frequency-domain resources that is available for transmitting the second signal are same, or sizes of the guard periods on both sides of the frequency-domain resource in the third-type candidate frequency-domain resources that is available for transmitting the second signal are different.

In some embodiments, the third-type candidate frequency-domain resources are configured by a network device; or
the third-type candidate frequency-domain resources are determined based on information reported by the AMP device; or
the third-type candidate frequency-domain resources are preempted and indicated to the AMP device by a network device.

In some embodiments, in a case where the third-type candidate frequency-domain resources are preempted and indicated to the AMP device by the network device, the third-type candidate frequency-domain resources are successfully preempted in a case where in the third-type candidate frequency-domain resources, there is no interference in a frequency-domain resource available for transmitting the first signal, in a frequency-domain resource available for transmitting the second signal, and between the frequency-domain resource available for transmitting the first signal and the frequency-domain resource available for transmitting the second signal.

In some embodiments, in a case where the third-type candidate frequency-domain resources are preempted and indicated to the AMP device by the network device, the third-type candidate frequency-domain resources and candidate frequency-domain resources adjacent to the third-type candidate frequency-domain resources are both preempted by the network device, or only the third-type candidate frequency-domain resources are preempted by the network device.

In some embodiments, a frequency-domain resource in the third-type candidate frequency-domain resources that is available for transmitting the first signal is configured by a network device, or a frequency-domain resource in the third-type candidate frequency-domain resources that is available for transmitting the first signal is specified by a protocol, or a frequency-domain resource in the third-type candidate frequency-domain resources that is available for transmitting the first signal is determined based on information reported by the AMP device; and/or,
a frequency-domain resource in the third-type candidate frequency-domain resources that is available for transmitting the second signal is configured by a network device, or a frequency-domain resource in the third-type candidate frequency-domain resources that is available for transmitting the second signal is specified by a protocol, or a frequency-domain resource in the third-type candidate frequency-domain resources that is available for transmitting the second signal is determined based on information reported by the AMP device.

In some embodiments, in a case where the frequency-domain resource in the third-type candidate frequency-domain resources that is available for transmitting the first signal is configured by the network device, a configuration granularity of the frequency-domain resource in the third-type candidate frequency-domain resources that is available for transmitting the first signal includes one of: an AMP granularity, an AMP group granularity, or a cell granularity; and/or,
in a case where the frequency-domain resource in the third-type candidate frequency-domain resources that is available for transmitting the second signal is configured by the network device, a configuration granularity of the frequency-domain resource in the third-type candidate frequency-domain resources that is available for transmitting the second signal includes one of: an AMP granularity, an AMP group granularity, or a cell granularity.

In some embodiments, different AMP devices share a candidate frequency-domain resource that is available for transmitting the second signal, or different AMP devices use different candidate frequency-domain resources that are available for transmitting the second signal.

In some embodiments, in a case where the different AMP devices share the candidate frequency-domain resource that is available for transmitting the second signal, the different AMP devices transmit the second signal by using a frequency-division multiplexing (FDM) mode.

In some embodiments, within a deployment frequency band corresponding to the AMP device, different candidate frequency-domain resources do not overlap with each other, or different candidate frequency-domain resources partially overlap with each other.

In some embodiments, the candidate frequency-domain resource is one of: a channel, a system bandwidth, a carrier bandwidth, a BWP, an aggregation/set/binding of a plurality of BWPs, an aggregation/set/binding of a plurality of subcarriers, or an aggregation/set/binding of a plurality of PRBs.

In some embodiments, the second signal is a signal transmitted periodically, or the second signal is a signal transmitted based on an event trigger, or the second signal is a signal transmitted with being bound to the first signal, or the second signal is a signal transmitted continuously.

In some embodiments, the second signal is a single-frequency point signal, or the second signal is a multi-frequency point signal.

In some embodiments, the second signal is a narrowband signal with a bandwidth less than or equal to a preset value.

In some embodiments, the processing unit 320 is further configured to perform power harvesting based on the first signal and/or the second signal.

In some embodiments, the third signal is associated with a high-order component obtained from the cross-modulation or inter-modulation processing of the first signal and the second signal.

In some embodiments, the first signal and the second signal are transmitted from a same device, or the first signal and the second signal are transmitted from different devices.

In some embodiments, the first signal carries control information and/or data information.

In some embodiments, the second signal is a reference radio frequency signal.

In some embodiments, the above-mentioned communication unit may be a communication interface or a transceiver, or an input/output interface of a communication chip or a system on chip. The above-mentioned processing unit may be one or more processors.

It should be understood that the AMP device 300 according to the embodiments of the present disclosure may correspond to the AMP device in the method embodiments of the present disclosure, and the above-mentioned and other operations and/or functions of each unit in the AMP device 300 are respectively for implementing the corresponding procedures of the AMP device in the method 200 shown in FIG. 10, which will not be repeated here for the sake of brevity.

FIG. 16 shows a schematic block diagram of a communication device 400 according to the embodiments of the present disclosure. As shown in FIG. 16, the communication device 400 is a first communication device, and the communication device 400 includes:
a communication unit 410, configured to transmit a first signal and/or a second signal to an ambient power (AMP) device.
where a third signal obtained from a cross-modulation or inter-modulation processing of the first signal and the second signal is used to decode the first signal;
where in a case where the first communication device only transmits the first signal, the second signal is transmitted to the AMP device by a second communication device triggered by the first communication device; or, in a case where the first communication device only transmits the second signal, the second signal is transmitted to the AMP device after a trigger of a second communication device.

In some embodiments, a center frequency point of the first signal is different from a center frequency point of the second signal; and/or a center frequency point of a frequency-domain resource used for transmitting the first signal is different from a center frequency point of a frequency-domain resource used for transmitting the second signal.

In some embodiments, a frequency-domain resource used for transmitting the first signal is a candidate frequency-domain resource, or a frequency-domain resource used for transmitting the first signal is a portion of a candidate frequency-domain resource; and/or
a frequency-domain resource used for transmitting the second signal is a candidate frequency-domain resource, or a frequency-domain resource used for transmitting the second signal is a portion of a candidate frequency-domain resource.

In some embodiments, the candidate frequency-domain resource used for transmitting the first signal is different from the candidate frequency-domain resource used for transmitting the second signal, or the candidate frequency-domain resource used for transmitting the first signal is same as the candidate frequency-domain resource used for transmitting the second signal.

In some embodiments, in a case where the candidate frequency-domain resource used for transmitting the first signal is different from the candidate frequency-domain resource used for transmitting the second signal, all candidate frequency-domain resources within a deployment frequency band corresponding to the AMP device include m first-type candidate frequency-domain resources and n second-type candidate frequency-domain resources, where the first-type candidate frequency-domain resources are candidate frequency-domain resources that are available for transmitting the first signal, and the second-type candidate frequency-domain resources are candidate frequency-domain resources that are available for transmitting the second signal, and m and n are both positive integers.

In some embodiments, the m first-type candidate frequency-domain resources are all candidate frequency-domain resources except the n second-type candidate frequency-domain resources within the deployment frequency band corresponding to the AMP device.

In some embodiments, the second-type candidate frequency-domain resources within the deployment frequency band corresponding to the AMP device are not available for transmitting a signal other than the second signal.

In some embodiments, in a case where n=1, an interval between a center frequency point of the candidate frequency-domain resource used for transmitting the first signal and a center frequency point of the candidate frequency-domain resource used for transmitting the second signal is greater than or equal to X₁ frequency-domain units, and/or an interval between a center frequency point of the first signal and a center frequency point of the second signal is greater than or equal to X₁ frequency-domain units, and X₁ is a positive integer.

In some embodiments, a frequency-domain unit in the X₁ frequency-domain units is one of: a candidate frequency-domain resource, a channel, a system bandwidth, a carrier, a subcarrier, a physical resource block (PRB), a bandwidth part (BWP), megahertz (MHz), kilohertz (kHz), or hertz (Hz).

In some embodiments, in a case where n>2, each of the second-type candidate frequency-domain resources within the deployment frequency band corresponding to the AMP device is associated with a set of first-type candidate frequency-domain resources in the first-type candidate frequency-domain resources in the deployment frequency band corresponding to the AMP device.

In some embodiments, an association relationship between the first-type candidate frequency-domain resources and the second-type candidate frequency-domain resources is specified by a protocol, or an association relationship between the first-type candidate frequency-domain resources and the second-type candidate frequency-domain resources is configured by a network device, or an association relationship between the first-type candidate frequency-domain resources and the second-type candidate frequency-domain resources is determined based on information reported by the AMP device.

In some embodiments, in a case where n>2, the deployment frequency band corresponding to the AMP device includes a plurality of sets of bound candidate frequency-domain resources;
where each set of bound candidate frequency-domain resources in the plurality of sets of bound candidate frequency-domain resources includes at least one of the first-type candidate frequency-domain resources and at least one of the second-type candidate frequency-domain resources.

In some embodiments, the plurality of sets of bound candidate frequency-domain resources are specified by a protocol, or the plurality of sets of bound candidate frequency-domain resources are configured by a network device, or the plurality of sets of bound candidate frequency-domain resources are determined based on information reported by the AMP device.

In some embodiments, in a case where the plurality of sets of bound candidate frequency-domain resources are configured by the network device, the plurality of sets of bound candidate frequency-domain resources are preempted and indicated to the AMP device by the network device, or the plurality of sets of bound candidate frequency-domain resources are semi-statically or dynamically configured by the network device.

In some embodiments, in each set of bound candidate frequency-domain resources in the plurality of sets of bound candidate frequency-domain resources, the first-type candidate frequency-domain resource is adjacent to the second-type candidate frequency-domain resource, or the first-type candidate frequency-domain resource is not adjacent to the second-type candidate frequency-domain resource.

In some embodiments, in each set of bound candidate frequency-domain resources in the plurality of sets of bound candidate frequency-domain resources, the first-type candidate frequency-domain resource and the second-type candidate frequency-domain resource satisfy a preset relationship.

In some embodiments, in each set of bound candidate frequency-domain resources in the plurality of sets of bound candidate frequency-domain resources, the first-type candidate frequency-domain resource and the second-type candidate frequency-domain resource satisfy an equation:

$${F}_{1} = {F}_{2} + Δ F ;$$

where F₁ represents the first-type candidate frequency-domain resource, F₂ represents the second-type candidate frequency-domain resource, and ΔF represents a frequency-domain interval.

In some embodiments, the m first-type candidate frequency-domain resources are configured by a network device; or
the m first-type candidate frequency-domain resources are preempted and indicated to the AMP device by a network device; or
the m first-type candidate frequency-domain resources are determined based on information reported by the AMP device; or
the m first-type candidate frequency-domain resources are associated with at least one of: an identifier of the AMP device, or an identifier of an AMP group to which the AMP device belongs.

In some embodiments, in a case where the m first-type candidate frequency-domain resources are configured by the network device, a configuration granularity of the m first-type candidate frequency-domain resources includes one of: an AMP granularity, an AMP group granularity, or a cell granularity.

In some embodiments, a frequency-domain resource in the first-type candidate frequency-domain resources that is available for transmitting the first signal is configured by a network device, or a frequency-domain resource in the first-type candidate frequency-domain resources that is available for transmitting the first signal is specified by a protocol, or a frequency-domain resource in the first-type candidate frequency-domain resources that is available for transmitting the first signal is determined based on information reported by the AMP device.

In some embodiments, in a case where the frequency-domain resource in the first-type candidate frequency-domain resources that is available for transmitting the first signal is configured by the network device, a configuration granularity of the frequency-domain resource in the first-type candidate frequency-domain resources that is available for transmitting the first signal includes one of: an AMP granularity, an AMP group granularity, or a cell granularity.

In some embodiments, the n second-type candidate frequency-domain resources are specified by a protocol; or
the n second-type candidate frequency-domain resources are configured by a network device; or
the n second-type candidate frequency-domain resources are determined based on information reported by the AMP device; or
the n second-type candidate frequency-domain resources are preempted and indicated to the AMP device by a network device.

In some embodiments, in a case where the n second-type candidate frequency-domain resources are configured by the network device, a configuration granularity of the n second-type candidate frequency-domain resources includes one of: an AMP granularity, an AMP group granularity, or a cell granularity.

In some embodiments, a frequency-domain resource in the second-type candidate frequency-domain resources that is available for transmitting the second signal is configured by a network device, or a frequency-domain resource in the second-type candidate frequency-domain resources that is available for transmitting the second signal is specified by a protocol, or a frequency-domain resource in the second-type candidate frequency-domain resources that is available for transmitting the second signal is determined based on information reported by the AMP device.

In some embodiments, in a case where the frequency-domain resource in the second-type candidate frequency-domain resources that is available for transmitting the second signal is configured by the network device, a configuration granularity of the frequency-domain resource in the second-type candidate frequency-domain resources that is available for transmitting the second signal includes one of: an AMP granularity, an AMP group granularity, or a cell granularity.

In some embodiments, in a case where the candidate frequency-domain resource used for transmitting the first signal is same as the candidate frequency-domain resource used for transmitting the second signal, all candidate frequency-domain resources within the deployment frequency band corresponding to the AMP device includes third-type candidate frequency-domain resources, where the third-type candidate frequency-domain resources are candidate frequency-domain resources that are available for transmitting the first signal and the second signal, and s is a positive integer.

In some embodiments, a frequency-domain resource in the third-type candidate frequency-domain resources that is available for transmitting the first signal is different from a frequency-domain resource in the third-type candidate frequency-domain resources that is available for transmitting the second signal.

In some embodiments, an interval between a frequency-domain resource in the third-type candidate frequency-domain resources that is available for transmitting the first signal and a frequency-domain resource in the third-type candidate frequency-domain resources that is available for transmitting the second signal is greater than or equal to X₂ frequency-domain units, and X₂ is a positive integer.

In some embodiments, a frequency-domain unit in the X₂ frequency-domain units is one of: a channel, a system bandwidth, a carrier, a subcarrier, a PRB, a BWP, MHz, kHz, or Hz.

In some embodiments, there are guard periods on both sides of a frequency-domain resource in the third-type candidate frequency-domain resources that is available for transmitting the second signal, where the guard periods are not available for transmitting a radio frequency signal.

In some embodiments, sizes of the guard periods on both sides of the frequency-domain resource in the third-type candidate frequency-domain resources that is available for transmitting the second signal are same, or sizes of the guard periods on both sides of the frequency-domain resource in the third-type candidate frequency-domain resources that is available for transmitting the second signal are different.

In some embodiments, the third-type candidate frequency-domain resources are configured by a network device; or
the third-type candidate frequency-domain resources are determined based on information reported by the AMP device; or
the third-type candidate frequency-domain resources are preempted and indicated to the AMP device by a network device.

In some embodiments, in a case where the third-type candidate frequency-domain resources are preempted and indicated to the AMP device by the network device, the third-type candidate frequency-domain resources are successfully preempted in a case where in the third-type candidate frequency-domain resources, there is no interference in a frequency-domain resource available for transmitting the first signal, in a frequency-domain resource available for transmitting the second signal, and between the frequency-domain resource available for transmitting the first signal and the frequency-domain resource available for transmitting the second signal.

In some embodiments, in a case where the third-type candidate frequency-domain resources are preempted and indicated to the AMP device by the network device, the third-type candidate frequency-domain resources and candidate frequency-domain resources adjacent to the third-type candidate frequency-domain resources are both preempted by the network device, or only the third-type candidate frequency-domain resources are preempted by the network device.

In some embodiments, a frequency-domain resource in the third-type candidate frequency-domain resources that is available for transmitting the first signal is configured by a network device, or a frequency-domain resource in the third-type candidate frequency-domain resources that is available for transmitting the first signal is specified by a protocol, or a frequency-domain resource in the third-type candidate frequency-domain resources that is available for transmitting the first signal is determined based on information reported by the AMP device; and/or,
a frequency-domain resource in the third-type candidate frequency-domain resources that is available for transmitting the second signal is configured by a network device, or a frequency-domain resource in the third-type candidate frequency-domain resources that is available for transmitting the second signal is specified by a protocol, or a frequency-domain resource in the third-type candidate frequency-domain resources that is available for transmitting the second signal is determined based on information reported by the AMP device.

In some embodiments, in a case where the frequency-domain resource in the third-type candidate frequency-domain resources that is available for transmitting the first signal is configured by the network device, a configuration granularity of the frequency-domain resource in the third-type candidate frequency-domain resources that is available for transmitting the first signal includes one of: an AMP granularity, an AMP group granularity, or a cell granularity; and/or,
in a case where the frequency-domain resource in the third-type candidate frequency-domain resources that is available for transmitting the second signal is configured by the network device, a configuration granularity of the frequency-domain resource in the third-type candidate frequency-domain resources that is available for transmitting the second signal includes one of: an AMP granularity, an AMP group granularity, or a cell granularity.

In some embodiments, different AMP devices share a candidate frequency-domain resource that is available for transmitting the second signal, or different AMP devices use different candidate frequency-domain resources that are available for transmitting the second signal.

In some embodiments, in a case where the different AMP devices share the candidate frequency-domain resource that is available for transmitting the second signal, the different AMP devices transmit the second signal by using a frequency-division multiplexing (FDM) mode.

In some embodiments, within a deployment frequency band corresponding to the AMP device, different candidate frequency-domain resources do not overlap with each other, or different candidate frequency-domain resources partially overlap with each other.

In some embodiments, the candidate frequency-domain resource is one of: a channel, a system bandwidth, a carrier bandwidth, a BWP, an aggregation/set/binding of a plurality of BWPs, an aggregation/set/binding of a plurality of subcarriers, or an aggregation/set/binding of a plurality of PRBs.

In some embodiments, the second signal is a signal transmitted periodically, or the second signal is a signal transmitted based on an event trigger, or the second signal is a signal transmitted with being bound to the first signal, or the second signal is a signal transmitted continuously.

In some embodiments, the second signal is a single-frequency point signal, or the second signal is a multi-frequency point signal.

In some embodiments, the second signal is a narrowband signal with a bandwidth less than or equal to a preset value.

In some embodiments, the first signal and/or the second signal is used by the AMP device for power harvesting.

In some embodiments, the third signal is associated with a high-order component obtained from the cross-modulation or inter-modulation processing of the first signal and the second signal.

In some embodiments, the first signal and the second signal are transmitted from a same device, or the first signal and the second signal are transmitted from different devices.

In some embodiments, the first signal carries control information and/or data information.

In some embodiments, the second signal is a reference radio frequency signal.

In some embodiments, the first communication device is one of: an access point (AP), a station (STA), a base station, a terminal device, or a transmission reception point (TRP).

In some embodiments, the above-mentioned communication unit may be a communication interface or a transceiver, or an input/output interface of a communication chip or a system on chip. The above-mentioned processing unit may be one or more processors.

It should be understood that the communication device 400 according to the embodiments of the present disclosure may correspond to the first communication device in the method embodiments of the present disclosure, and the above-mentioned and other operations and/or functions of each unit in the communication device 400 are respectively for implementing the corresponding procedures of the first communication device in the method 200 shown in FIG. 10, which will not be repeated here for the sake of brevity.

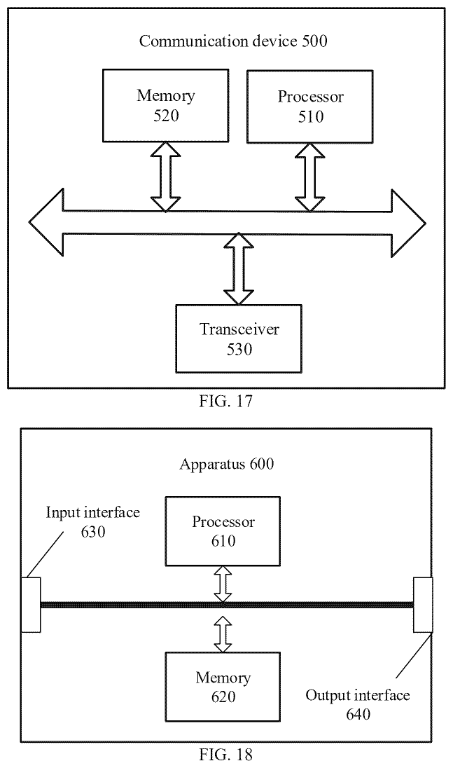

FIG. 17 is a schematic structural diagram of a communication device 500 provided in the embodiments of the present disclosure. The communication device 500 shown in FIG. 17 includes a processor 510, and the processor 510 may call and execute a computer program from a memory to implement the methods in the embodiments of the present disclosure.

In some embodiments, as shown in FIG. 17, the communication device 500 may further include a memory 520. The processor 510 may call and execute a computer program from the memory 520 to implement the methods in the embodiments of the present disclosure.

Here, the memory 520 may be a separate device independent of the processor 510, or may be integrated into the processor 510.

In some embodiments, as shown in FIG. 17, the communication device 500 may further include a transceiver 530, and the processor 510 may control the transceiver 530 to communicate with other devices, for example, to transmit information or data to other devices, or receive information or data transmitted from other devices.

Here, the transceiver 530 may include a transmitter and a receiver. The transceiver 530 may further include an antenna, and a number of antennas may be one or more.

In some embodiments, the processor 510 may implement the functions of the processing unit in the AMP device 300, or the processor 510 may implement the functions of a processing unit in the communication device 400, which will not be repeated here for the sake of brevity.

In some embodiments, the transceiver 530 may implement the functions of the communication unit in the AMP device 300, which will not be repeated here for the sake of brevity.

In some embodiments, the transceiver 530 may implement the functions of the communication unit in the communication device 400, which will not be repeated here for the sake of brevity.

In some embodiments, the communication device 500 may be the communication device 400 of the embodiments of the present disclosure, and the communication device 500 may implement the corresponding procedures implemented by the first communication device in each method of the embodiments of the present disclosure, which will not be repeated here for the sake of brevity.

In some embodiments, the communication device 500 may be the AMP device 300 of the embodiments of the present disclosure, and the communication device 500 may implement the corresponding procedures implemented by the AMP device in each method of the embodiments of the present disclosure, which will not be repeated here for the sake of brevity.

FIG. 18 is a schematic structural diagram of an apparatus in the embodiments of the present disclosure. The apparatus 600 shown in FIG. 18 includes a processor 610, and the processor 610 may call and execute a computer program from a memory to implement the methods in the embodiments of the present disclosure.

In some embodiments, as shown in FIG. 18, the apparatus 600 may further include a memory 620. The processor 610 may call and execute a computer program from the memory 620 to implement the methods in the embodiments of the present disclosure.

Here, the memory 620 may be a separate device independent of the processor 610, or may be integrated into the processor 610.

In some embodiments, the processor 610 may implement the functions of the processing unit in the AMP device 300, or the processor 610 may implement the functions of a processing unit in the communication device 400, which will not be repeated here for the sake of brevity.

In some embodiments, the apparatus 600 may further include an input interface 630. The processor 610 may control the input interface 630 to communicate with other devices or chips, for example, to obtain information or data transmitted from other devices or chips. Optionally, the processor 610 may be located on-chip or off-chip.

In some embodiments, the input interface 630 may implement the functions of the communication unit in the AMP device 300, or the input interface 630 may implement the functions of the communication unit in the communication device 400.

In some embodiments, the apparatus 600 may further include an output interface 640. The processor 610 may control the output interface 640 to communicate with other devices or chips, for example, to output information or data to other devices or chips. Optionally, the processor 610 may be located on-chip or off-chip.

In some embodiments, the output interface 640 may implement the functions of the communication unit in the AMP device 300, or the output interface 640 may implement the functions of the communication unit in the communication device 400.

In some embodiments, the apparatus may be applied to the communication device 400 in the embodiments of the present disclosure, and the apparatus may implement the corresponding procedures implemented by the first communication device in each method of the embodiments of the present disclosure, which will not be repeated here for the sake of brevity.

In some embodiments, the apparatus may be applied to the AMP device 300 in the embodiments of the present disclosure, and the apparatus may implement the corresponding procedures implemented by the AMP device in each method of the embodiments of the present disclosure, which will not be repeated here for the sake of brevity.

In some embodiments, the apparatus mentioned in the embodiments of the present disclosure may also be a chip. For example, it may be a system-on-chip, a system chip, a chip system, or an on-chip system chip.

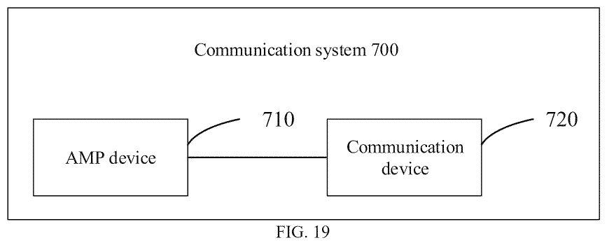

FIG. 19 is a schematic block diagram of a communication system 700 provided in the embodiments of the present disclosure. As shown in FIG. 19, the communication system 700 includes an AMP device 710 and a communication device 720.

Here, the AMP device 710 may be configured to implement the corresponding functions implemented by the AMP device in the above-mentioned methods, and the communication device 720 may be configured to implement the corresponding functions implemented by the first communication device in the above-mentioned methods, which will not be repeated here for the sake of brevity.

It should be understood that the processor of the embodiments of the present disclosure may be an integrated circuit chip with a signal processing capability. In the implementation process, various steps of the above method embodiments may be completed by an integrated logic circuit of hardware in the processor or an instruction in a software form. The above processor may be a general-purpose processor, a Digital Signal Processor (DSP), an Application Specific Integrated Circuit (ASIC), a Field Programmable Gate Array (FPGA) or other programmable logic devices, a discrete gate or transistor logic device, a discrete hardware component. Various methods, steps and logical block diagrams disclosed in the embodiments of the present disclosure may be implemented or performed. A general-purpose processor may be a microprocessor, or the processor may also be any conventional processor, etc. The steps of the method disclosed in combination with the embodiments of the present disclosure may be directly embodied as being performed and completed by a hardware decoding processor, or by using a combination of hardware and software modules in the decoding processor. The software module may be located in the mature storage medium in the art such as the random memory, the flash memory, the read-only memory, the programmable read-only memory or electrically erasable programmable memory, the register. The storage medium is located in the memory, and the processor reads the information in the memory and completes the steps of the above methods in combination with its hardware.

It may be understood that, the memory in the embodiments of the present disclosure may be a volatile memory or a non-volatile memory, or may include both volatile and non-volatile memories. Herein, the non-volatile memory may be a Read-Only Memory (ROM), a programmable read-only memory (Programmable ROM, PROM), an erasable programmable read-only memory (Erasable PROM, EPROM), an electrically erasable programmable read-only memory (Electrically EPROM, EEPROM) or a flash memory. The volatile memory may be a Random Access Memory (RAM), which is used as an external cache. Through illustrative, rather than limiting, illustration, many forms of RAMs are available, for example, a static random access memory (Static RAM, SRAM), a dynamic random access memory (Dynamic RAM, DRAM), a synchronous dynamic random access memory (Synchronous DRAM, SDRAM), a double data rate synchronous dynamic random access memory (Double Data Rate SDRAM, DDR SDRAM), an enhanced synchronous dynamic random access memory (Enhanced SDRAM, ESDRAM), a synchronous link dynamic random access memory (Synchlink DRAM, SLDRAM) and a direct rambus random access memory (Direct Rambus RAM, DR RAM). It should be noted that the memory of the system and the method described herein are intended to include, but not limited to, these and any other suitable types of memories.

It should be understood that the above memory is exemplary but not limiting illustration, e.g., the memory in embodiments of the present disclosure may also be a static Random Access Memory (static RAM, SRAM), a Dynamic Random Access Memory (dynamic RAM, DRAM), a synchronous DRAM (SDRAM), a double data rate SDRAM (DDR SDRAM), an enhanced SDRAM (ESDRAM), a synch link DRAM (SLDRAM), and a Direct Rambus RAM (DR RAM), etc. That is, the memory in the embodiments of the present disclosure is intended to include, but not limited to, these and any other suitable types of memories.

The embodiments of the present disclosure further provide a non-transitory computer-readable storage medium for storing a computer program.

In some embodiments, the non-transitory computer-readable storage medium may be applied to the communication device in the embodiments of the present disclosure, and the computer program causes a computer to perform the corresponding procedure implemented by the first communication device in the various methods of the embodiments of the present disclosure, which will not be repeated here for the sake of brevity.

In some embodiments, the non-transitory computer-readable storage medium may be applied to the AMP device in the embodiments of the present disclosure, and the computer program causes a computer to perform the corresponding procedure implemented by the AMP device in various methods of the embodiments of the present disclosure, which will not be repeated here for the sake of brevity.

The embodiments of the present disclosure further provide a computer program product including computer program instructions.

In some embodiments, the computer program product may be applied to the communication device in the embodiments of the present disclosure, and the computer program instructions cause a computer to perform the corresponding procedure implemented by the first communication device in the various methods of the embodiments of the present disclosure, which will not be repeated here for the sake of brevity.

In some embodiments, the computer program product may be applied to the AMP device in the embodiments of the present disclosure, and the computer program instruction causes a computer to perform the corresponding procedure implemented by the AMP device in various methods of the embodiments of the present disclosure, which will not be repeated here for the sake of brevity.

The embodiments of the present disclosure further provide a computer program.

In some embodiments, the computer program may be applied to the communication device in the embodiments of the present disclosure, the computer program when being executed on a computer, causes the computer to perform the corresponding procedure implemented by the first communication device in various methods of the embodiments of the present disclosure, which will not be repeated here for the sake of brevity.

In some embodiments, the computer program may be applied to the AMP device in the embodiments of the present disclosure, the computer program when being executed on a computer, causes the computer to perform the corresponding procedure implemented by the AMP device in various methods of the embodiments of the present disclosure, which will not be repeated here for the sake of brevity.

Those ordinary skilled in the art may realize that units and algorithm steps of the examples described in combination with the embodiments disclosed herein can be implemented in electronic hardware or in a combination of computer software and electronic hardware. Whether these functions are performed by way of hardware or software depends on a specific application and a design constraint of the technical solution. A skilled person may use different methods for each specific application, to implement the described functions, but such implementation should not be considered beyond the scope of the present disclosure.

It may be clearly understood by those skilled in the art that, for convenience and brevity of the description, the working procedures of the system, the apparatus and the unit described above may refer to the corresponding procedures in the above method embodiments, which will not be repeated here.

In the several embodiments provided by the present disclosure, it should be understood that, the disclosed system, apparatus, and method may be implemented in other ways. For example, the apparatus embodiments described above are only schematic, for example, division of the units is only division of logical functions, and there may be other division methods in an actual implementation, for example, a plurality of units or components may be combined or integrated into another system, or some features may be ignored or not performed. On the other hand, the coupling or direct coupling or communicative connection between each other as shown or discussed may be indirect coupling or communicative connection of apparatus or units via some interfaces, which may be electrical, mechanical, or in other forms.

The units illustrated as separate components may be or may not be physically separated, and the components shown as units may be or may not be physical units, that is, they may be located in one place, or may be distributed onto a plurality of network units. A part or all of the units may be selected according to actual needs, to implement the purpose of the schemes of the embodiments.

In addition, the various functional units in the various embodiments of the present disclosure may be integrated into one processing unit, or the various units may exist physically separately, or two or more units may be integrated into one unit.

If the described functions are implemented in the form of a software functional unit and sold or used as an independent product, they may be stored in a non-transitory computer-readable storage medium. Based on this understanding, the technical solutions of the present disclosure essentially, or a part of the technical solutions that contributes to the prior art, or a part of the technical solutions, may be embodied in the form of a software product, and the computer software product is stored in a non-transitory storage medium, and includes a plurality of instructions for enabling a computer device (which may be a personal computer, a server, or a network device, etc.) to perform all or some of steps of the methods described in the various embodiments of the present disclosure. And, the storage medium mentioned above includes a USB flash drive (U disk), a mobile hard disk, a Read-Only Memory (ROM), a Random Access Memory (RAM), a diskette, or an optical disk, and various media that may store program codes.

The above content is only exemplary implementations of the present disclosure, but the protection scope of the present disclosure is not limited thereto, and any skilled person familiar with this technical field may easily think of changes or substitutions within the technical scope disclosed in the present disclosure, which should be all covered within the protection scope of the present disclosure. Therefore, the protection scope of the present disclosure should be determined based on the protection scope of the claims.

What is claimed is:

1. A wireless communication method, comprising:
receiving, by an ambient power (AMP) device, a first signal and a second signal;
performing, by the AMP device, a cross-modulation or inter-modulation processing on the first signal and the second signal to obtain a third signal; and
decoding, by the AMP device, the first signal according to the third signal.

2. The method according to claim 1, wherein
a center frequency point of the first signal is different from a center frequency point of the second signal; and/or
a center frequency point of a frequency-domain resource used for transmitting the first signal is different from a center frequency point of a frequency-domain resource used for transmitting the second signal.

3. The method according to claim 1, wherein
a frequency-domain resource used for transmitting the first signal is a candidate frequency-domain resource, or a frequency-domain resource used for transmitting the first signal is a portion of a candidate frequency-domain resource; and/or
a frequency-domain resource used for transmitting the second signal is a candidate frequency-domain resource, or a frequency-domain resource used for transmitting the second signal is a portion of a candidate frequency-domain resource.

4. The method according to claim 3, wherein the candidate frequency-domain resource used for transmitting the first signal is different from the candidate frequency-domain resource used for transmitting the second signal, or the candidate frequency-domain resource used for transmitting the first signal is same as the candidate frequency-domain resource used for transmitting the second signal.

5. The method according to claim 4, wherein
in a case where the candidate frequency-domain resource used for transmitting the first signal is different from the candidate frequency-domain resource used for transmitting the second signal, all candidate frequency-domain resources within a deployment frequency band corresponding to the AMP device comprise m first-type candidate frequency-domain resources and n second-type candidate frequency-domain resources, wherein the first-type candidate frequency-domain resources are candidate frequency-domain resources that are available for transmitting the first signal, and the second-type candidate frequency-domain resources are candidate frequency-domain resources that are available for transmitting the second signal, and m and n are both positive integers.

6. The method according to claim 5, wherein
the m first-type candidate frequency-domain resources are all candidate frequency-domain resources except the n second-type candidate frequency-domain resources within the deployment frequency band corresponding to the AMP device.

7. The method according to claim 5, wherein the second-type candidate frequency-domain resources within the deployment frequency band corresponding to the AMP device are not available for transmitting a signal other than the second signal.

8. The method according to claim 5, wherein
in a case where n=1, an interval between a center frequency point of the candidate frequency-domain resource used for transmitting the first signal and a center frequency point of the candidate frequency-domain resource used for transmitting the second signal is greater than or equal to X₁ frequency-domain units, and/or an interval between a center frequency point of the first signal and a center frequency point of the second signal is greater than or equal to X₁ frequency-domain units, and X₁ is a positive integer; or
in a case where n>2, each of the second-type candidate frequency-domain resources within the deployment frequency band corresponding to the AMP device is associated with a set of first-type candidate frequency-domain resources in the first-type candidate frequency-domain resources in the deployment frequency band corresponding to the AMP device; or
in a case where n>2, the deployment frequency band corresponding to the AMP device comprises a plurality of sets of bound candidate frequency-domain resources;
wherein each set of bound candidate frequency-domain resources in the plurality of sets of bound candidate frequency-domain resources comprises at least one of the first-type candidate frequency-domain resources and at least one of the second-type candidate frequency-domain resources.

9. The method according to claim 8, wherein in each set of bound candidate frequency-domain resources in the plurality of sets of bound candidate frequency-domain resources, the first-type candidate frequency-domain resource is adjacent to the second-type candidate frequency-domain resource, or the first-type candidate frequency-domain resource is not adjacent to the second-type candidate frequency-domain resource.

10. The method according to claim 8, wherein
in each set of bound candidate frequency-domain resources in the plurality of sets of bound candidate frequency-domain resources, the first-type candidate frequency-domain resource and the second-type candidate frequency-domain resource satisfy a preset relationship; wherein
in each set of bound candidate frequency-domain resources in the plurality of sets of bound candidate frequency-domain resources, the first-type candidate frequency-domain resource and the second-type candidate frequency-domain resource satisfy an equation:
$${F}_{1} = {F}_{2} + Δ F ;$$
wherein F₁ represents the first-type candidate frequency-domain resource, F₂ represents the second-type candidate frequency-domain resource, and ΔF represents a frequency-domain interval.

11. The method according to claim 5, wherein
the m first-type candidate frequency-domain resources are configured by a network device; or
the m first-type candidate frequency-domain resources are preempted and indicated to the AMP device by a network device; or
the m first-type candidate frequency-domain resources are determined based on information reported by the AMP device; or
the m first-type candidate frequency-domain resources are associated with at least one of: an identifier of the AMP device, or an identifier of an AMP group to which the AMP device belongs;
wherein in a case where the m first-type candidate frequency-domain resources are configured by the network device, a configuration granularity of the m first-type candidate frequency-domain resources comprises one of: an AMP granularity, an AMP group granularity, or a cell granularity.

12. The method according to claim 5, wherein
a frequency-domain resource in the first-type candidate frequency-domain resources that is available for transmitting the first signal is configured by a network device, or a frequency-domain resource in the first-type candidate frequency-domain resources that is available for transmitting the first signal is specified by a protocol, or a frequency-domain resource in the first-type candidate frequency-domain resources that is available for transmitting the first signal is determined based on information reported by the AMP device;
wherein in a case where the frequency-domain resource in the first-type candidate frequency-domain resources that is available for transmitting the first signal is configured by the network device, a configuration granularity of the frequency-domain resource in the first-type candidate frequency-domain resources that is available for transmitting the first signal comprises one of: an AMP granularity, an AMP group granularity, or a cell granularity.

13. The method according to claim 5, wherein
the n second-type candidate frequency-domain resources are specified by a protocol; or
the n second-type candidate frequency-domain resources are configured by a network device; or
the n second-type candidate frequency-domain resources are determined based on information reported by the AMP device; or
the n second-type candidate frequency-domain resources are preempted and indicated to the AMP device by a network device;
wherein in a case where the n second-type candidate frequency-domain resources are configured by the network device, a configuration granularity of the n second-type candidate frequency-domain resources comprises one of: an AMP granularity, an AMP group granularity, or a cell granularity.

14. The method according to claim 5, wherein
a frequency-domain resource in the second-type candidate frequency-domain resources that is available for transmitting the second signal is configured by a network device, or a frequency-domain resource in the second-type candidate frequency-domain resources that is available for transmitting the second signal is specified by a protocol, or a frequency-domain resource in the second-type candidate frequency-domain resources that is available for transmitting the second signal is determined based on information reported by the AMP device;
wherein in a case where the frequency-domain resource in the second-type candidate frequency-domain resources that is available for transmitting the second signal is configured by the network device, a configuration granularity of the frequency-domain resource in the second-type candidate frequency-domain resources that is available for transmitting the second signal comprises one of: an AMP granularity, an AMP group granularity, or a cell granularity.

15. The method according to claim 4, wherein in a case where the candidate frequency-domain resource used for transmitting the first signal is same as the candidate frequency-domain resource used for transmitting the second signal, all candidate frequency-domain resources within the deployment frequency band corresponding to the AMP device comprises third-type candidate frequency-domain resources, wherein the third-type candidate frequency-domain resources are candidate frequency-domain resources that are available for transmitting the first signal and the second signal, and s is a positive integer.

16. The method according to claim 15, wherein a frequency-domain resource in the third-type candidate frequency-domain resources that is available for transmitting the first signal is different from a frequency-domain resource in the third-type candidate frequency-domain resources that is available for transmitting the second signal; or
an interval between a frequency-domain resource in the third-type candidate frequency-domain resources that is available for transmitting the first signal and a frequency-domain resource in the third-type candidate frequency-domain resources that is available for transmitting the second signal is greater than or equal to X₂ frequency-domain units, and X₂ is a positive integer; or
there are guard periods on both sides of a frequency-domain resource in the third-type candidate frequency-domain resources that is available for transmitting the second signal, wherein the guard periods are not available for transmitting a radio frequency signal.

17. The method according to claim 16, wherein
sizes of the guard periods on both sides of the frequency-domain resource in the third-type candidate frequency-domain resources that is available for transmitting the second signal are same, or sizes of the guard periods on both sides of the frequency-domain resource in the third-type candidate frequency-domain resources that is available for transmitting the second signal are different.

18. The method according to claim 15, wherein
the third-type candidate frequency-domain resources are configured by a network device; or
the third-type candidate frequency-domain resources are determined based on information reported by the AMP device; or
the third-type candidate frequency-domain resources are preempted and indicated to the AMP device by a network device.

19. An ambient power (AMP) device, comprising:
a communication unit, configured to receive a first signal and a second signal; and
a processing unit, configured to perform a cross-modulation or inter-modulation processing on the first signal and the second signal to obtain a third signal; and
the processing unit, further configured to decode the first signal according to the third signal.

20. A communication device, wherein the communication device is a first communication device, and the communication device comprises:
a communication unit, configured to transmit a first signal and/or a second signal to an ambient power (AMP) device;
wherein a third signal obtained from a cross-modulation or inter-modulation processing of the first signal and the second signal is used to decode the first signal;
wherein in a case where the first communication device only transmits the first signal, the second signal is transmitted to the AMP device by a second communication device triggered by the first communication device; or, in a case where the first communication device only transmits the second signal, the second signal is transmitted to the AMP device after a trigger of a second communication device.
